(19) United States
(12) Patent Application Publication
(10) Pub. No.: US 2025/0139053 A1
(43) Pub. Date: May 1, 2025

(54) SNAPSHOT MANAGEMENT USING METADATA TAGGING

(71) Applicant: NetApp, Inc., San Jose, CA (US)

(72) Inventors: Sivakumar Chandrasekaran, Fremont, CA (US); Anuja Inamdar, San Jose, CA (US); Raghvendra Dixit, San Jose, CA (US); Ajay Kushwah, San Ramon, CA (US)

(21) Appl. No.: 18/496,339

(22) Filed: Oct. 27, 2023

(51) Int. Cl. G06F 16/11; G06F 16/16; G06F 16/174

(52) U.S. Cl. CPC G06F 16/128; G06F 16/164; G06F 16/1756

(57) ABSTRACT

A method, computing device, and non-transitory machine-readable medium for generating and maintaining snapshots. An image (snapshot) of a volume is generated for a point in time that aligns with a base schedule time in a base schedule. The image includes metadata pointing to data blocks stored on the volume at the base schedule time and is designated for use as a base snapshot of the volume at the base schedule time. In response to determining that the base schedule time aligns with a supplementary schedule time in a supplementary schedule, the image can be further designated for use as a supplementary snapshot of the volume at the supplementary schedule time. Restoring data corresponding to the supplementary schedule time includes computing all the deltas between the base snapshots created between the supplementary schedule time and an immediately preceding supplementary schedule time in the supplementary schedule.

### TECHNICAL FIELD

The present description relates to data protection using snapshots, and more specifically, to methods and systems for reducing the storage capacity needed for maintaining snapshots according to different types of schedules.

### BACKGROUND

Replication is one method that is used to recover data that is stored on volumes at different points in time. For example, replication can be used for disaster recovery, data archiving, testing software, data mining, performing rollbacks of a system to a previous data, and other data protection or data recovery purposes. Replication can also be used to capture data transfer between endpoints in data fabric. One type of technology used for such replication includes using snapshots (which can also be called snapshot copies or snapshot images). A snapshot includes a read-only point-in-time image of a volume. The image itself captures the metadata of a volume to point to the actual data blocks on disk. By copying metadata rather than coping data blocks, a snapshot can represent only changes to the files of a volume since the preceding snapshot with efficiency with reduced storage space. However, currently available methods and systems for generating and storing snapshots may use at least more storage space than is desired when multiple different types (e.g., daily, monthly, etc.) of snapshots are being stored.

### BRIEF DESCRIPTION OF THE DRAWINGS

The present disclosure is best understood from the following detailed description when read with the accompanying figures.

FIG. 1 is a schematic diagram illustrating a computing environment depicted in accordance with one or more example embodiments.

FIG. 2 is a schematic diagram illustrating a network environment depicted in accordance with one or more example embodiments.

FIG. 3 is a schematic block diagram illustrating a scheduler operating within a node depicted in accordance with one or more example embodiments.

FIG. 4 is a schematic diagram of snapshots associated with different periodic schedules depicted in accordance with one or more example embodiments.

FIG. 5 is a flow diagram of a process for managing snapshots according to different periodic schedules depicted in accordance with one or more example embodiments.

FIG. 6 is a flow diagram of a process for managing snapshots according to different periodic schedules depicted in accordance with one or more example embodiments.

FIG. 7 is a schematic diagram of a storage platform depicted in according to embodiments of the present disclosure.

### DETAILED DESCRIPTION

### I. Overview

The embodiments described herein recognize that generating and maintaining snapshots generated according to various schedules (e.g., daily snapshots, weekly snapshots, monthly snapshots, yearly snapshots, etc.) can become expensive and require more storage capacity than desired. For example, storing daily snapshots in addition to weekly snapshots may consume a larger amount of storage space than is desirable. Further, storing the snapshots generated according to different schedules may lead to duplications or redundancies that may consume a larger amount of storage space than is desirable.

The embodiments recognize and take into account that it may be desirable to have methods and systems for reducing the overall computing resources (e.g., storage space, processing power, etc.) that is needed to generate and maintain snapshots for different types of schedules. Thus, the embodiments described herein provide methods and systems for reducing snapshot overhead with respect to such computing resources, including storage space (e.g., active volume consumption).

In one or more embodiments, snapshots are generated for a base schedule. This base schedule is periodic (e.g., has time points that recur at a regular base interval of time). Various snapshots generated according to the base schedule can be tagged using metadata to enable those snapshots to be used for other time points in one or more other supplementary schedules, each of which may be regular, irregular, user-defined, or set up in some other manner. Restoring data corresponding to any one of the other supplementary schedules includes computing a plurality of deltas between a plurality of base snapshots created between a selected supplementary schedule time and an immediately preceding supplementary schedule time in the supplementary schedule. Computing the deltas between successive pairs of base snapshots (e.g., 28, 29, 30, or 31 daily snapshots) may use reduced computing resources (e.g., processing power, memory) as compared to computing the delta between two successive monthly snapshots.

In one or more embodiments, the snapshots generated according to one periodic schedule (e.g., daily) are tagged using metadata tags to allow for their use in other periodic schedules (e.g., weekly, monthly, etc.). For example, the base schedule may be a daily schedule. A supplementary schedule may be a weekly schedule. Each snapshot of the base schedule (base snapshot) that also falls on a scheduled time of the supplementary schedule is tagged with a metadata tag indicating its use for the supplementary schedule. In this manner, a separate series of snapshots only for the supplementary schedule does not need to be generated or maintained, thereby reducing the computing resources and expense involved with snapshot generation and maintenance. For example, using metadata tags to tag an individual snapshot for use across multiple schedules conserves storage space, which reduces overall expense. Reducing the snapshot overhead on the volume may additionally improve efficiency across the system.

### II. Example Architectures for Computing/Networking Environments

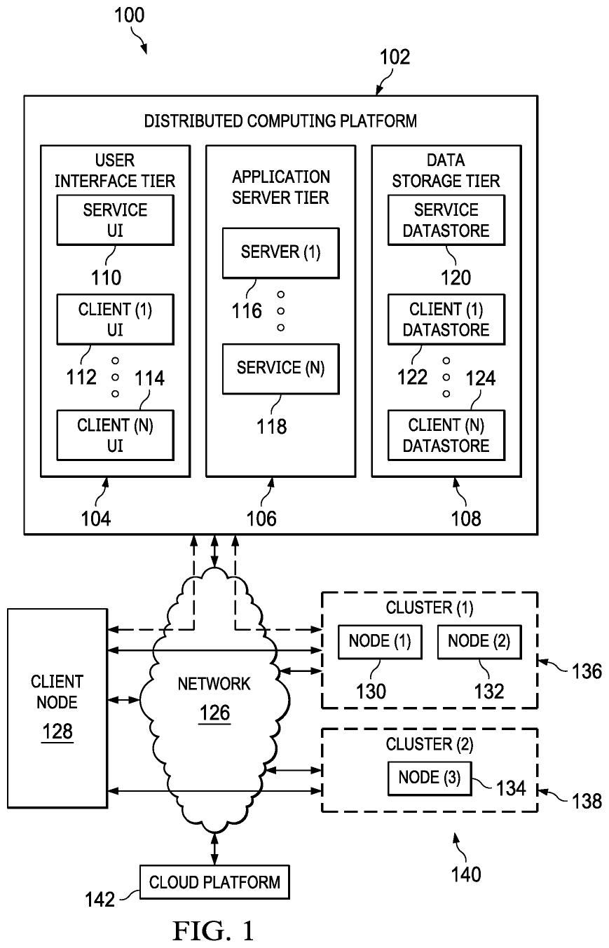

Referring now to the figures, FIG. 1 is a schematic diagram illustrating a computing environment 100 in accordance with one or more example embodiments. The computing environment 100 may be one example of an implementation for an environment in which snapshots may be generated and managed according to one or more example embodiments described herein. The computing environment 100 includes a distributed computing platform 102 that can be used to manage the storage of and access to data on behalf of client devices and/or storage resources. The distributed computing environment 100 may be implemented using a cloud storage environment, a multi-tenant platform, a hyperscale infrastructure comprising scalable server architectures, virtual networking, or a combination thereof.

The distributed computing platform 102 may include, for example, a user interface tier 104, an application server tier 106, and a data storage tier 108. The user interface tier 104 may include a service user interface 110 and one or more client user interfaces for one or more respective client nodes. For example, the one or more client user interfaces may include client (1) user interface 112 and, in some cases, one or more other client user interfaces up to client (N) user interface 114. The application server tier 106 may include one or more servers including, for example, server (1) 116 up to server (N) 118. The number of servers in application server tier 106 may be the same as or different from the number of client user interfaces in user interface tier 104. The data storage tier 108 includes service datastore 120 and one or more client datastores for one or more respective client nodes. For example, the one or more client datastores may include client (1) datastore 122 and, in some cases, one or more other client datastores up to client (N) datastore 124.

The distributed computing platform 102 is in communication via network 126 with one or more client nodes (e.g., client node 128), one or more nodes (e.g., a first node 130, a second node 132, a third node 134, etc.), or both, where the various nodes may form one or more clusters (e.g., a first cluster 136, a second cluster 138, etc.). The embodiments described herein may include actions that can be implemented within a client node (e.g., the client node 128), one or more nodes (e.g., the first node 130, the second node 132, the third node 134), or both. A node may include a storage controller, a server, an on-premise device, a virtual machine such as a storage virtual machine, hardware, software, or a combination thereof. The one or more nodes may be configured to manage the storage and access to data on behalf of the client node 128 and/or other client devices.

One or more of the embodiments described herein include operations implemented across the distributed computing platform 102, client node 128, one or more of first node 130, second node 132, and/or third node 134, or a combination thereof. For example, the client node 128 may transmit operations, such as data operations to read data and write data, and metadata operations (e.g., a create file operation, a rename directory operation, a resize operation, a set attribute operation, etc.), over the network 126 to the first node 130 for implementation by the first node 130 upon storage. The first node 130 may store data associated with the operations within volumes or other data objects/structures hosted within locally attached storage, remote storage hosted by other computing devices accessible over the network 126, storage provided by the distributed computing platform 102, etc. The first node 130 may replicate the data and/or the operations to other computing devices, such as to the second node 132, the third node 134, a storage virtual machine executing within the distributed computing platform 102, etc., so that one or more replicas of the data are maintained. For example, the third node 134 may host a destination storage volume that is maintained as a replica of a source storage volume of the first node 130. Such replicas can be used for disaster recovery and failover.

In one or more embodiments, the one or more nodes (e.g., a first node 130, a second node 132, a third node 134, etc.), which may form one or more clusters (e.g., a first cluster 136, a second cluster 138, etc.), are part of a storage platform (e.g., storage platform 140). Storage platform 140 may include a storage operating system (e.g., which may include ONTAP). The storage operating system may be implemented at a node level, a cluster level, a platform level, a cloud level, or a combination thereof. For example, without limitation, the storage operating system may include multiple modules, each operating on a different node. As another example, the storage operating system may include multiple modules, each operating across or for a different cluster. As another example, the storage operating system may include one module outside the clusters but in communication with the clusters and/or nodes. The storage platform 140 and/or storage operating system may be implemented in a manner similar to, for example, the storage platform and/or storage operating system, respectively, described in U.S. patent application Ser. No. 17/588,901, entitled “Detached Global Scheduler,” filed Jan. 31, 202, which is incorporated herein by reference in its entirety.

In one or more embodiments, the techniques described herein include actions implemented by a storage operating system or are implemented by a separate module that interacts with the storage operating system. The storage operating system may be hosted by the client node 128, the distributed computing platform 102, or across a combination thereof. In an example, the storage operating system may execute within a storage virtual machine, a hyperscaler, or some other computing environment. The storage operating system may implement a storage file system to logically organize data within storage devices as one or more storage objects and provide a logical/virtual representation of how the storage objects are organized on the storage devices. A storage object may comprise any logically definable storage element stored by the storage operating system (e.g., a volume stored by the first node 130, a cloud object stored by the distributed computing platform 102, etc.). Each storage object may be associated with a unique identifier that uniquely identifies the storage object. For example, a volume may be associated with a volume identifier uniquely identifying that volume from other volumes. The storage operating system also manages client access to the storage objects.

The storage operating system may implement a file system for logically organizing data. For example, the storage operating system may implement a write-anywhere file layout for a volume where modified data for a file may be written to any available location as opposed to a write-in-place architecture where modified data is written to the original location, thereby overwriting the previous data.

In one or more embodiments, the file system may be implemented through a file system layer that stores data of the storage objects in an on-disk format representation that is block-based (e.g., data may be stored within 4 kilobyte blocks). Pointer elements may be used to identify files and file attributes such as creation time, access permissions, size and block location, other types of attributes, or a combination thereof. Such pointer elements may be referred to as index nodes (inodes). For example, an inode may be a data structure that points to a file system object (e.g., a file, a folder, or a directory) in the file system. The inode may point to blocks that make up a file and may also contain the metadata of the file. In some cases, an inode may itself have a certain capacity and may be able to store a file itself. As one example, the inode may have a 288-byte capacity and may be capable of storing a file that is less than 64 bytes. In one or more embodiments, a given volume may have a finite number of inodes.

In one or more embodiments, deduplication may be implemented by a deduplication module associated with the storage operating system to improve storage efficiency. For example, inline deduplication may ensure blocks are deduplicated before being written to a storage device. Inline deduplication uses a data structure, such as an in-core hash store, which maps fingerprints of data-to-data blocks of the storage device storing the data. Whenever data is to be written to the storage device, a fingerprint of that data is calculated, and the data structure is looked up using the fingerprint to find duplicates (e.g., potentially duplicate data already stored within the storage device). If duplicate data is found, then the duplicate data is loaded from the storage device and a byte-by-byte comparison may be performed to ensure that the duplicate data is an actual duplicate of the data to be written to the storage device. If the data to be written is a duplicate of the loaded duplicate data, then the data to be written to disk is not redundantly stored to the storage device. Instead, a pointer or other reference is stored in the storage device in place of the data to be written to the storage device. The pointer points to the duplicate data already stored in the storage device. A reference count for the data may be incremented to indicate that the pointer now references the data. If at some point the pointer no longer references the data (e.g., the deduplicated data is deleted and thus no longer references the data in the storage device), then the reference count is decremented. In this way, inline deduplication is able to deduplicate data before the data is written to disk. This improves the storage efficiency of the storage device.

In one or more embodiments, compression may be implemented by a compression module associated with the storage operating system. The compression module may utilize various types of compression techniques to replace longer sequences of data (e.g., frequently occurring and/or redundant sequences) with shorter sequences, such as by using Huffman coding, arithmetic coding, compression dictionaries, etc. For example, an uncompressed portion of a file may comprise “ggggnnnnnnqqqqqqqqqq,” which is compressed to become “4g6n10q”. In this way, the size of the file can be reduced to improve storage efficiency. Compression may be implemented for compression groups. A compression group may correspond to a compressed group of blocks. The compression group may be represented by virtual volume block numbers. The compression group may comprise contiguous or non-contiguous blocks.

In one or more embodiments, various types of synchronization may be implemented by a synchronization module associated with the storage operating system. In an example, synchronous replication may be implemented, such as between the first node 130 and the second node 132. It may be appreciated that the synchronization module may implement synchronous replication between any devices within the computing environment 100, such as between the first node 130 of the first cluster 136 and the third node 134 of the second cluster 138 and/or between a node of a cluster and an instance of a node or virtual machine in the distributed computing platform 102.

For example, during synchronous replication, the first node 130 may receive a write operation from the client node 128. The write operation may target a file stored within a volume managed by the first node 130. The first node 130 replicates the write operation to create a replicated write operation. The first node 130 locally implements the write operation upon the file within the volume. The first node 130 also transmits the replicated write operation to a synchronous replication target, such as the second node 132 that maintains a replica volume as a replica of the volume maintained by the first node 130. The second node 132 will execute the replicated write operation upon the replica volume so that file within the volume and the replica volume comprises the same data. After, the second node 132 will transmit a success message to the first node 130. With synchronous replication, the first node 130 does not respond with a success message to the client node 128 for the write operation until the write operation is executed upon the volume and the first node 130 receives the success message that the second node 132 executed the replicated write operation upon the replica volume.

In other embodiments, asynchronous replication may be implemented, such as between the first node 130 and the third node 134. It may be appreciated that the synchronization module may implement asynchronous replication between any devices within the computing environment 100, such as between the first node 130 of the first cluster 136 and the distributed computing platform 102. In an example, the first node 130 may establish an asynchronous replication relationship with the third node 134. The first node 130 may capture a baseline snapshot of a first volume as a point in time representation of the first volume. The first node 130 may utilize the baseline snapshot to perform a baseline transfer of the data within the first volume to the third node 134 in order to create a second volume within the third node 134 comprising data of the first volume as of the point in time at which the baseline snapshot was created.

After the baseline transfer, the first node 130 may subsequently create snapshots of the first volume over time. As part of asynchronous replication, an incremental transfer is performed between the first volume and the second volume. In particular, a snapshot of the first volume is created. The snapshot is compared with a prior snapshot that was previously used to perform the last asynchronous transfer (e.g., the baseline transfer or a prior incremental transfer) of data to identify a difference in data of the first volume between the snapshot and the prior snapshot (e.g., changes to the first volume since the last asynchronous transfer). Accordingly, the difference in data is incrementally transferred from the first volume to the second volume. In this way, the second volume will comprise the same data as the first volume as of the point in time when the snapshot was created for performing the incremental transfer. It may be appreciated that other types of replication may be implemented, such as semi-sync replication.

In one or more embodiments, the first node 130 may store data or a portion thereof within storage hosted by the distributed computing platform 102 by transmitting the data within objects to the distributed computing platform 102. In one example, the first node 130 may locally store frequently accessed data within locally attached storage. Less frequently accessed data may be transmitted to the distributed computing platform 102 for storage within a data storage tier 108. The data storage tier 108 may store data within a service datastore 120. Further, the data storage tier 108 may store client specific data within client data stores assigned to such clients such as a client (1) datastore 122 used to store data of a client (1) and a client (N) datastore 124 used to store data of a client (N). The data stores may be physical storage devices or may be defined as logical storage, such as a virtual volume, logical unit numbers (LUNs), or other logical organizations of data that can be defined across one or more physical storage devices. In another example, the first node 130 transmits and stores all client data to the distributed computing platform 102. In yet another example, the client node 128 transmits and stores the data directly to the distributed computing platform 102 without the use of the first node 130.

The management of storage and access to data can be performed by one or more storage virtual machines (SVMs) or other storage applications that provide software as a service (SaaS) such as storage software services. In one example, an SVM may be hosted within the client node 128, within the first node 130, or within the distributed computing platform 102 such as by the application server tier 106. In another example, one or more SVMs may be hosted across one or more of the client node 128, the first node 130, and the distributed computing platform 102. The one or more SVMs may host instances of the storage operating system.

In one or more embodiments, the storage operating system may be implemented for the distributed computing platform 102. The storage operating system may allow client devices to access data stored within the distributed computing platform 102 using various types of protocols, such as a Network File System (NFS) protocol, a Server Message Block (SMB) protocol and Common Internet File System (CIFS), and Internet Small Computer Systems Interface (iSCSI), and/or other protocols. The storage operating system may provide various storage services, such as disaster recovery (e.g., the ability to non-disruptively transition client devices from accessing a primary node that has failed to a secondary node that is taking over for the failed primary node), backup and archive function, replication such as asynchronous and/or synchronous replication, deduplication, compression, high availability storage, cloning functionality (e.g., the ability to clone a volume, such as a space efficient flex clone), snapshot functionality (e.g., the ability to create snapshots and restore data from snapshots), data tiering (e.g., migrating infrequently accessed data to slower/cheaper storage), encryption, managing storage across various platforms such as between on-premise storage systems and multiple cloud systems, etc.

In one example of the distributed computing platform 102, one or more SVMs may be hosted by the application server tier 106. For example, a server (1) 116 is configured to host SVMs used to execute applications such as storage applications that manage the storage of data of the client (1) within the client (1) datastore 122. Thus, an SVM executing on the server (1) 116 may receive data and/or operations from the client node 128 and/or the first node 130 over the network 126. The SVM executes a storage application and/or an instance of the storage operating system to process the operations and/or store the data within the client (1) datastore 122. The SVM may transmit a response back to the client node 128 and/or the first node 130 over the network 126, such as a success message or an error message. In this way, the application server tier 106 may host SVMs, services, and/or other storage applications using the server (1) 116, the server (N) 118, etc.

A user interface tier 104 of the distributed computing platform 102 may provide the client node 128 and/or the first node 130 with access to user interfaces associated with the storage and access of data and/or other services provided by the distributed computing platform 102. In an example, a service user interface 110 may be accessible from the distributed computing platform 102 for accessing services subscribed to by clients and/or nodes, such as data replication services, application hosting services, data security services, human resource services, warehouse tracking services, accounting services, etc. For example, client user interfaces may be provided to corresponding clients, such as a client (1) user interface 112, a client (N) user interface 114, etc. The client (1) can access various services and resources subscribed to by the client (1) through the client (1) user interface 112, such as access to a web service, a development environment, a human resource application, a warehouse tracking application, and/or other services and resources provided by the application server tier 106, which may use data stored within the data storage tier 108.

The client node 128 and/or the first node 130 may subscribe to certain types and amounts of services and resources provided by the distributed computing platform 102. For example, the client node 128 may establish a subscription to have access to three virtual machines, a certain amount of storage, a certain type/amount of data redundancy, a certain type/amount of data security, certain service level agreements (SLAs) and service level objectives (SLOs), latency guarantees, bandwidth guarantees, access to execute or host certain applications, etc. Similarly, the first node 130 can establish a subscription to have access to certain services and resources of the distributed computing platform 102.

In one or more embodiments, the client node 128, the first node 130, the second node 132, the third node 134, one or more other nodes in first cluster 136, one or more other noes in cluster 138

As shown, a variety of clients, such as the client node 128 and the first node 130, incorporating and/or incorporated into a variety of computing devices may communicate with the distributed computing platform 102 through one or more networks, such as the network 126. For example, a client may incorporate and/or be incorporated into a client application (e.g., software) implemented at least in part by one or more of the computing devices.

Examples of computing devices include, but are not limited to, personal computers, server computers, desktop computers, nodes, storage servers, nodes, laptop computers, notebook computers, tablet computers or personal digital assistants (PDAs), smart phones, cell phones, and consumer electronic devices incorporating one or more computing device components, such as one or more electronic processors, microprocessors, central processing units (CPU), or controllers. Examples of networks include, but are not limited to, networks utilizing wired and/or wireless communication technologies and networks operating in accordance with any suitable networking and/or communication protocol (e.g., the Internet). In use cases involving the delivery of customer support services, the computing devices noted represent the endpoint of the customer support delivery process, i.e., the consumer's device.

The distributed computing platform 102, which may be implemented using a multi-tenant business data processing platform or cloud computing environment, may include multiple processing tiers, including the user interface tier 104, the application server tier 106, and a data storage tier 108. The user interface tier 104 may maintain multiple user interfaces, including graphical user interfaces and/or web-based interfaces. The user interfaces may include the service user interface 110 for a service to provide access to applications and data for a client (e.g., a “tenant”) of the service, as well as one or more user interfaces that have been specialized/customized in accordance with user specific requirements (e.g., as discussed above), which may be accessed via one or more APIs.

The service user interface 110 may include components enabling a tenant to administer the tenant's participation in the functions and capabilities provided by the distributed computing platform 102, such as accessing data, causing execution of specific data processing operations, etc. Each processing tier may be implemented with a set of computers, virtualized computing environments such as a storage virtual machine or storage virtual server, and/or computer components including computer servers and processors, and may perform various functions, methods, processes, or operations as determined by the execution of a software application or set of instructions.

The data storage tier 108 may include one or more data stores, which may include the service datastore 120 and one or more client data stores 122-124. Each client data store may contain tenant-specific data that is used as part of providing a range of tenant-specific business and storage services or functions, including but not limited to ERP, CRM, eCommerce, Human Resources management, payroll, storage services, etc. Data stores may be implemented with any suitable data storage technology, including structured query language (SQL) based relational database management systems (RDBMS), file systems hosted by operating systems, object storage, etc.

The distributed computing platform 102 may be a multi-tenant and service platform operated by an entity in order to provide multiple tenants with a set of business-related applications, data storage, and functionality. These applications and functionality may include ones that a business uses to manage various aspects of its operations. For example, the applications and functionality may include providing web-based access to business information systems, thereby allowing a user with a browser and an Internet or intranet connection to view, enter, process, or modify certain types of business information or any other type of information.

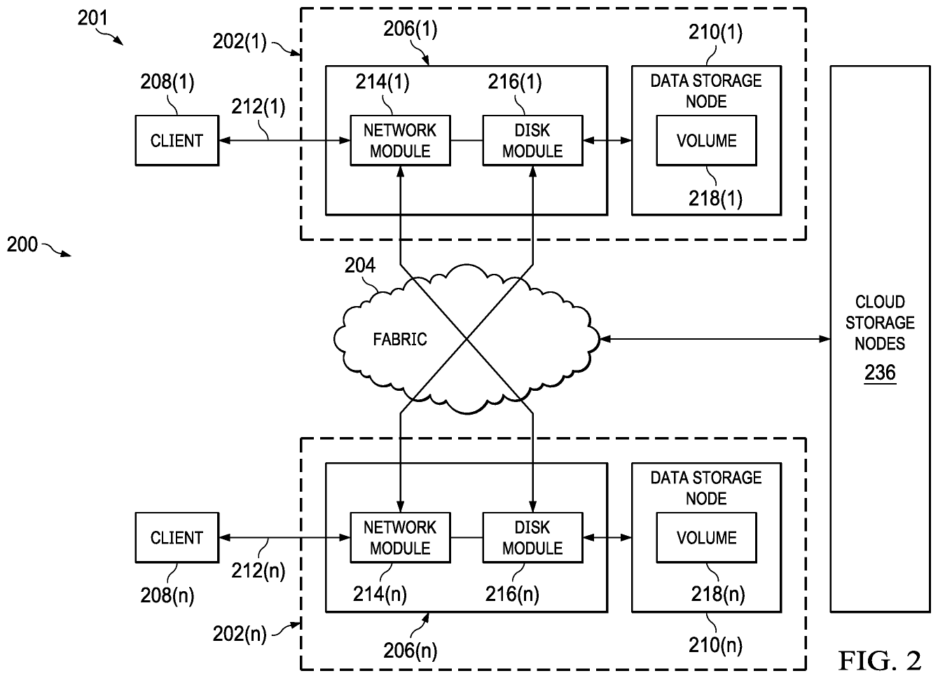

FIG. 2 is a schematic diagram illustrating a network environment 200 in accordance with one or more example embodiments. The network environment 200 illustrates another architecture for the principles described above with respect to FIG. 1. The network environment 200 may be another example of environment in which snapshots may be generated and maintained according to one or more example embodiments described herein. For example, the network environment 200 illustrates another architecture for a storage platform (e.g., storage platform 201). Storage platform 201.

The network environment 200, which may take the form of a clustered network environment, includes data storage apparatuses 202(1)-202(n) that are coupled over a cluster or cluster fabric 204 that includes one or more communication network(s) and facilitates communication between the data storage apparatuses 202(1)-202(n) (and one or more modules, components, etc. therein, such as, node computing devices 206(1)-206(n) (also referred to as node computing devices), for example), although any number of other elements or components can also be included in the network environment 200 in other examples. This technology provides a number of advantages including methods, non-transitory computer-readable media, and computing devices that implement the techniques described herein.

In this example, node computing devices 206(1)-206(n) can be primary or local storage controllers or secondary or remote storage controllers that provide client devices 208(1)-208(n) (also referred to as client nodes) with access to data stored within data storage nodes 210(1)-210(n) (also referred to as data storage devices) and cloud storage node(s) 236 (also referred to as cloud storage device(s)). The node computing devices 206(1)-206(n) may be implemented as hardware, software (e.g., a storage virtual machine), or combination thereof.

The data storage apparatuses 202(1)-202(n) and/or node computing devices 206(1)-206(n) of the examples described and illustrated herein are not limited to any particular geographic areas and can be clustered locally and/or remotely via a cloud network, or not clustered in other examples. Thus, in one example the data storage apparatuses 202(1)-202(n) and/or node computing device 206(1)-206(n) can be distributed over a plurality of storage systems located in a plurality of geographic locations (e.g., located on-premise, located within a cloud computing environment, etc.); while in another example a network can include data storage apparatuses 202(1)-202(n) and/or node computing device 206(1)-206(n) residing in a same geographic location (e.g., in a single on-site rack).

In the illustrated example, one or more of the client devices 208(1)-208(n), which may be, for example, personal computers (PCs), computing devices used for storage (e.g., storage servers), or other computers or peripheral devices, are coupled to the respective data storage apparatuses 202(1)-202(n) by network connections 212(1)-212(n). Network connections 212(1)-212(n) may include a local area network (LAN) or wide area network (WAN) (i.e., a cloud network), for example, that utilize TCP/IP and/or one or more Network Attached Storage (NAS) protocols, such as a Common Internet Filesystem (CIFS) protocol or a Network Filesystem (NFS) protocol to exchange data packets, a Storage Area Network (SAN) protocol, such as Small Computer System Interface (SCSI) or Fiber Channel Protocol (FCP), an object protocol, such as simple storage service (S3), and/or non-volatile memory express (NVMe), for example.

Illustratively, the client devices 208(1)-208(n) may be general-purpose computers running applications and may interact with the data storage apparatuses 202(1)-202(n) using a client/server model for exchange of information. That is, the client devices 208(1)-208(n) may request data from the data storage apparatuses 202(1)-202(n) (e.g., data on one of the data storage nodes 210(1)-210(n) managed by a network storage controller configured to process I/O commands issued by the client devices 208(1)-208(n)), and the data storage apparatuses 202(1)-202(n) may return results of the request to the client devices 208(1)-208(n) via the network connections 212(1)-212(n).

The node computing devices 206(1)-206(n) of the data storage apparatuses 202(1)-202(n) can include network or host nodes that are interconnected as a cluster to provide data storage and management services, such as to an enterprise having remote locations, cloud storage (e.g., a storage endpoint may be stored within cloud storage node(s) 236), etc., for example. Such node computing devices 206(1)-206(n) can be attached to the cluster fabric 204 at a connection point, redistribution point, or communication endpoint, for example. One or more of the node computing devices 206(1)-206(n) may be capable of sending, receiving, and/or forwarding information over a network communications channel, and could comprise any type of device that meets any or all of these criteria.

In an example, the node computing devices 206(1) and 206(n) may be configured according to a disaster recovery configuration whereby a surviving node provides switchover access to the storage nodes 210(1)-210(n) in the event a disaster occurs at a disaster storage site (e.g., the node computing device 206(1) provides client device 208(n) with switchover data access to data storage nodes 210(n) in the event a disaster occurs at the second storage site). In other examples, the node computing device 206(n) can be configured according to an archival configuration and/or the node computing devices 206(1)-206(n) can be configured based on another type of replication arrangement (e.g., to facilitate load sharing). Additionally, while two node computing devices are illustrated in FIG. 2, any number of node computing devices or data storage apparatuses can be included in other examples in other types of configurations or arrangements.

As illustrated in the network environment 200, node computing devices 206(1)-206(n) can include various functional components that coordinate to provide a distributed storage architecture. For example, the node computing devices 206(1)-206(n) can include network modules 214(1)-214(n) and disk modules 216(1)-216(n). Network modules 214(1)-214(n) can be configured to allow the node computing devices 206(1)-206(n) (e.g., network storage controllers) to connect with client devices 208(1)-208(n) over the network connections 212(1)-212(n), for example, allowing the client devices 208(1)-208(n) to access data stored in the network environment 200.

Further, the network modules 214(1)-214(n) can provide connections with one or more other components through the cluster fabric 204. For example, the network module 214(1) of node computing device 206(1) can access the data storage node 210(n) by sending a request via the cluster fabric 204 through the disk module 216(n) of node computing device 206(n) when the node computing device 206(n) is available. Alternatively, when the node computing device 206(n) fails, the network module 214(1) of node computing device 206(1) can access the data storage node 210(n) directly via the cluster fabric 204. The cluster fabric 204 can include one or more local and/or wide area computing networks (i.e., cloud networks) embodied as Infiniband, Fibre Channel (FC), or Ethernet networks, for example, although other types of networks supporting other protocols can also be used.

Disk modules 216(1)-216(n) can be configured to connect data storage nodes 210(1)-210(n), such as disks or arrays of disks, SSDs, flash memory, or some other form of data storage, to the node computing devices 206(1)-206(n). Often, disk modules 216(1)-216(n) communicate with the data storage nodes 210(1)-210(n) according to the SAN protocol, such as SCSI or FCP, for example, although other protocols can also be used. Thus, as seen from an operating system on node computing devices 206(1)-206(n), the data storage nodes 210(1)-210(n) can appear as locally attached. In this manner, different node computing devices 206(1)-206(n), etc. may access data blocks, files, or objects through the operating system, rather than expressly requesting abstract files.

While the network environment 200 illustrates an equal number of network modules 214(1)-214(n) and disk modules 216(1)-216(n), other examples may include a differing number of these modules. For example, there may be a plurality of network and disk modules interconnected in a cluster that do not have a one-to-one correspondence between the network and disk modules. That is, different node computing devices can have a different number of network and disk modules, and the same node computing device can have a different number of network modules than disk modules.

Further, one or more of the client devices 208(1)-208(n) can be networked with the node computing devices 206(1)-206(n) in the cluster, over the network connections 212(1)-212(n). As an example, respective client devices 208(1)-208(n) that are networked to a cluster may request services (e.g., exchanging of information in the form of data packets) of node computing devices 206(1)-206(n) in the cluster, and the node computing devices 206(1)-206(n) can return results of the requested services to the client devices 208(1)-208(n). In one example, the client devices 208(1)-208(n) can exchange information with the network modules 214(1)-214(n) residing in the node computing devices 206(1)-206(n) (e.g., network hosts) in the data storage apparatuses 202(1)-202(n).

In one example, the data storage apparatuses 202(1)-202(n) host aggregates corresponding to physical local and remote data storage devices, such as local flash or disk storage in the data storage nodes 210(1)-210(n), for example. One or more of the data storage nodes 210(1)-210(n) can include mass storage devices, such as disks of a disk array. The disks may comprise any type of mass storage devices, including but not limited to magnetic disk drives, flash memory, and any other similar media adapted to store information, including, for example, data and/or parity information.

The aggregates include volumes 218(1)-218(n) in this example, although any number of volumes can be included in the aggregates. The volumes 218(1)-218(n) are virtual data stores or storage objects that define an arrangement of storage and one or more filesystems within the network environment 200. Volumes 218(1)-218(n) can span a portion of a disk or other storage device, a collection of disks, or portions of disks, for example, and typically define an overall logical arrangement of data storage. In one example, volumes 218(1)-218(n) can include stored user data as one or more files, blocks, or objects that may reside in a hierarchical directory structure within the volumes 218(1)-218(n).

Volumes 218(1)-218(n) are typically configured in formats that may be associated with particular storage systems, and respective volume formats typically comprise features that provide functionality to the volumes 218(1)-218(n), such as providing the ability for volumes 218(1)-218(n) to form clusters, among other functionality. Optionally, one or more of the volumes 218(1)-218(n) can be in composite aggregates and can extend between one or more of the data storage nodes 210(1)-210(n) and one or more of the cloud storage node(s) 236 to provide tiered storage, for example, and other arrangements can also be used in other examples.

In one example, to facilitate access to data stored on the disks or other structures of the data storage nodes 210(1)-210(n), a filesystem may be implemented that logically organizes the information as a hierarchical structure of directories and files. In this example, respective files may be implemented as a set of disk blocks of a particular size that are configured to store information, whereas directories may be implemented as specially formatted files in which information about other files and directories are stored.

Data can be stored as files or objects within a physical volume and/or a virtual volume, which can be associated with respective volume identifiers. The physical volumes correspond to at least a portion of physical storage devices, such as the data storage nodes 210(1)-210(n) (e.g., a Redundant Array of Independent (or Inexpensive) Disks (RAID system)) whose address, addressable space, location, etc. does not change. Typically, the location of the physical volumes does not change in that the range of addresses used to access it generally remains constant.

Virtual volumes, in contrast, can be stored over an aggregate of disparate portions of different physical storage devices. Virtual volumes may be a collection of different available portions of different physical storage device locations, such as some available space from disks, for example. It will be appreciated that since the virtual volumes are not “tied” to any one particular storage device, virtual volumes can be said to include a layer of abstraction or virtualization, which allows it to be resized and/or flexible in some regards.

Further, virtual volumes can include one or more LUNs, directories, Qtrees, files, and/or other storage objects, for example. Among other things, these features, but more particularly the LUNs, allow the disparate memory locations within which data is stored to be identified, for example, and grouped as data storage unit. As such, the LUNs may be characterized as constituting a virtual disk or drive upon which data within the virtual volumes is stored within an aggregate. For example, LUNs are often referred to as virtual drives, such that they emulate a hard drive, while they actually comprise data blocks stored in various parts of a volume.

In one example, the data storage nodes 210(1)-210(n) can have one or more physical ports, wherein each physical port can be assigned a target address (e.g., SCSI target address). To represent respective volumes, a target address on the data storage nodes 210(1)-210(n) can be used to identify one or more of the LUNs. Thus, for example, when one of the node computing devices 206(1)-206(n) connects to a volume, a connection between the one of the node computing devices 206(1)-206(n) and one or more of the LUNs underlying the volume is created.

Respective target addresses can identify multiple of the LUNs, such that a target address can represent multiple volumes. The I/O interface, which can be implemented as circuitry and/or software in a storage adapter or as executable code residing in memory and executed by a processor, for example, can connect to volumes by using one or more addresses that identify the one or more of the LUNs.

The present embodiments may be implemented using hardware, software, firmware, or a combination thereof. Accordingly, it is understood that any operation of the computing systems of the computing environment 100, the network environment 200, or both may be implemented by a computing system using corresponding instructions stored on or in a non-transitory computer-readable medium accessible by a processing system. For the purposes of this description, a tangible computer-usable or computer-readable medium can be any apparatus that can store the program for use by or in connection with the instruction execution system, apparatus, or device. The medium may include non-volatile memory including magnetic storage, solid-state storage, optical storage, cache memory, and RAM.

### III. Example Architecture for Generating and Managing Snapshots

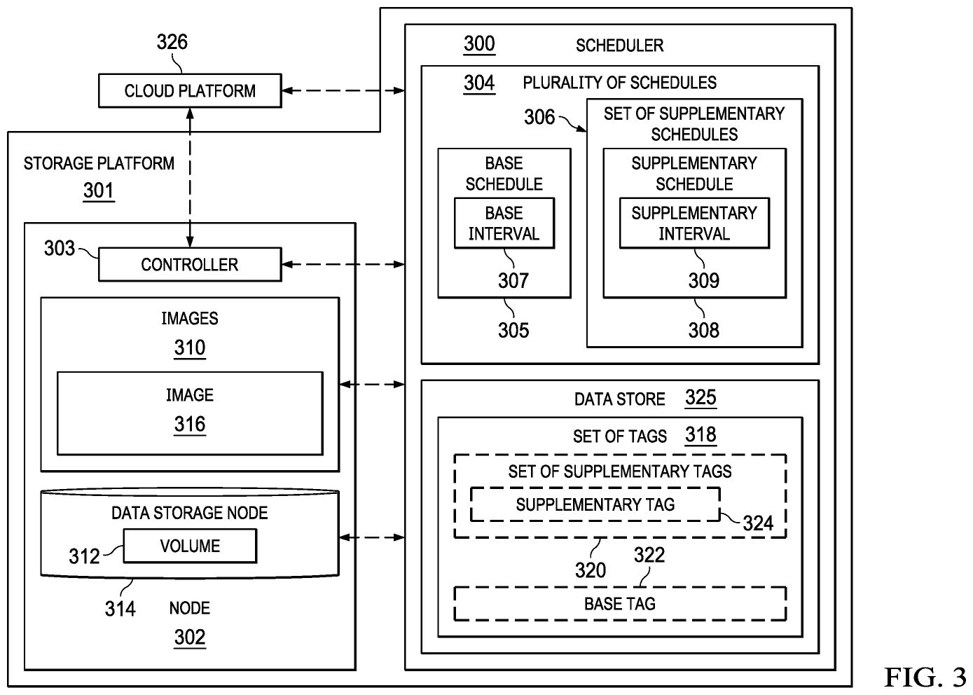

FIG. 3 is a schematic block diagram illustrating a scheduler operating within a storage platform 301 in accordance with one or more example embodiments. The scheduler 300 may be implemented within a storage platform 301. The storage platform 301 may be one example of an implementation for storage platform 140 in FIG. 1 and/or storage platform 201 in FIG. 2. The storage platform 301 may include one or more nodes, such as a node 302. The node 302 may of one example of an implementation for one of the node computing devices 206(1)-206(n) in FIG. 2 and/or the nodes shown in FIG. 1. The node 302 may include a network module, a disk module, or both.

Scheduler 300 may include hardware, software, firmware, or a combination thereof. Scheduler 300 may be implemented in one or more processors (e.g., one or more microprocessors) within storage platform 301. In one or more embodiments, scheduler 300 may be implemented outside of the node 302 and optionally, outside of a cluster to which node 302 may belong. Scheduler 300, however, may be in communication with a controller 303 of the node 302. In some cases, the controller 303 may be part of or may be in communication with a storage operating system for the storage platform 301. In some cases, the controller 303 includes one or more modules and/or policies for the generation of backup data. For example, the controller 303 may manage the generation of snapshots.

In some embodiments, scheduler 300 may be implemented within node 302. For example, scheduler 300 may be implemented as a module within the controller 303. In other examples, scheduler 300 may be implemented as a separate module within the node 302 that is in communication with the controller 303. Thus, scheduler 300 may be implemented in different ways including, for example, with at least a portion of scheduler 300 being implemented within node 302, at least a portion of scheduler 300 being implemented outside of node 302, or both.

Thus, it should be understood that one or more steps described as being performed by scheduler 300 within node 302 may alternatively be performed outside of node 302 (e.g., by a portion of scheduler 300 operating outside of node 302) (and, optionally, outside of a cluster within which node 302 operates). Similarly, it should be understood that one or more steps described as being performed by scheduler 300 outside of node 302 may alternatively be performed within node 302 (e.g., within a portion of scheduler 300 operating within controller 303 of node 302).

Node 302 may generate snapshots according to different types of schedules managed by scheduler 300. For example, scheduler 300 may maintain a plurality of schedules 304 for generating snapshots. These schedules 304 may be selected by one or more users, processes, or both. In one or more embodiments, schedules 304 includes at least two schedules. Schedules 304 may include two, three, four, five, six, seven, eight, or some other number of schedules. For example, schedules 304 may include a base schedule 305 and a set of supplementary schedules 306, with set of supplementary schedules 306 including one or more set of supplementary schedules. In some cases, the base schedule 305 may be a default schedule (e.g., set by a user, set as default upon initialization of node 302, etc.). In one or more embodiments, set of supplementary schedules 306 may be selected by a user. For example, scheduler 300 may be configured to receive user input that scheduler 300 uses to define one or more of set of supplementary schedules 306.

In one or more embodiments, base schedule 305 is a periodic schedule that includes a series of points in time (or sequence of points in time) that recur at a regular time interval, which may be referred to as base interval 307 (or a base time interval). Accordingly, these points in time, which may be referred to as base schedule times, have a frequency (or base frequency). In one or more embodiments, base interval 307 may be, for example, but is not limited to, a day, an hour, a minute, a week, a second, a fraction thereof, or some other time interval. Accordingly, in one or more embodiments, base schedule 305 may be a daily schedule (e.g., for generating daily snapshots), an hourly schedule (e.g., for generating hourly snapshots), an every-minute schedule (e.g., for generating snapshots every minute), or some other type of periodic schedule.

Set of supplementary schedules 306 includes one or more supplementary schedules. A supplementary schedule may be, for example, a periodic schedule for generating snapshots regularly. In other examples, a supplementary schedule is an irregular schedule for generating snapshots at one or more preselected points in time, one or more randomly selected (e.g., selected via a randomizer) points in time, one or more points in time that coincide with a number of preselected events, or a combination thereof.

Supplementary schedule 308 is an example of one selected supplementary schedule from the set of supplementary schedules 306. In one or more embodiments, supplementary schedule 308 is a periodic schedule for generating snapshots regularly according to a selected time interval, which may be referred to as a supplementary interval 309 (or supplementary time interval). Supplementary interval 309 is a time interval that is greater than base interval 307. Accordingly, when supplementary schedule 308 is periodic, supplementary schedule 308 includes schedule points in time that occur at a lower frequency than for base schedule 305. In one or more embodiments, supplementary interval 309 may be, for example, but is not limited to, a day, an hour, a minute, a week, a second, a month, a year, a quarter, 6 months, a fraction thereof, or some other time interval. Accordingly, supplementary schedule 308 may be an hourly schedule, a daily schedule, a weekly schedule, a biweekly schedule, a monthly schedule, a bimonthly schedule, a quarterly schedule, a yearly schedule, a biannual schedule, or some other type of periodic schedule. In one or more embodiments, supplementary interval 309 associated with the supplementary schedule 308 is a time interval that is a multiple of the base 307 associated with the base schedule 305.

In other embodiments, supplementary schedule 308 is an irregular schedule that does not align with a regular supplementary interval 309. For example, supplementary schedule 308 may be any schedule in which each of its time points coincides with a particular base schedule time of base schedule 305. For example, if base schedule 305 is a daily schedule, supplementary schedule 308 may include any supplementary schedule times that fall on or otherwise align with particular days of base schedule 305. As one example, if base schedule 305 is a daily schedule, supplementary schedule 309 may include supplementary schedule times that fall on, for example, without limitation, a 5^{th} day, a 10^{th} day, a 20^{th} day, a 25^{th} day, a 32^{nd} day, a 45^{th} day, a 52^{nd} day, etc. These supplementary schedule times may be defined by one or more users, processes, or both.

Node 302 generates snapshots by generating images 310 of volume 312 at the various points in time corresponding to base schedule 305. Volume 312 may be stored on data storage node 314, which is one example of an implementation for one of data storage nodes 210(1)-210(n) in FIG. 2. The volume 312 may be one example of an implementation for one of volumes 218(1)-218(n) in FIG. 2. Node 302 may provide access to the data stored on volume 312.

Each of images 310 generated by node 302 is a snapshot of volume 312. For example, each of images 310 may be a read-only, point-in-time file system image of volume 312 that includes metadata pointing to the blocks of data stored on the volume 312. Thus, the image does not contain the actual data on the volume 312 but rather, references the metadata pointing to the blocks of data. Image 316 is one example of the images 310 that can be generated by node 302. Image 316 includes metadata pointing to the blocks of data stored on the volume 312. Image 316 may be stored alongside the file system's data and may be a read-only, static, and immutable copy.

Each of the images 310 is associated with the base schedule 305 and therefore each of the images 310 is designated for use as a base snapshot (or base schedule snapshot). In one or more embodiments, each of the images 310 is tagged with a metadata tag that indicates that each image is designated for use as a base schedule snapshot. In other embodiments, images 310 are not tagged but scheduler 300 treats each of images 310 as being associated with base schedule 305.

At least a portion of the images 310 may also be associated with one or more of the set of supplementary schedules 306. Associating an image with a supplementary schedule (e.g., supplementary schedule 308) includes tagging the image to associate the image with that supplementary schedule. For example, a metadata tag may be added to the image to associate the image with the supplementary schedule. In some cases, a given image may be given multiple metadata tags to associate the image with multiple supplementary schedules.

In one or more embodiments, tagging an image with a metadata tag may include tagging the image with the metadata tag such that the metadata tag becomes includes as part of or connected to the image. In other embodiments, tagging an image with a metadata tag includes storing the metadata tag in association with an identifier for the image such that the metadata tag is “linked” to the image.

As one example, after generating image 316, scheduler 300 tags image 316 with set of tags 318. Set of tags 318 includes one or more metadata tags. Set of tags 318 may be selected from a set of tag options that includes a set of supplementary tags 320 and optionally, base tag 322. Each supplementary tag of the set of supplementary tags 320 corresponds to a respective one of set of supplementary schedules 306.

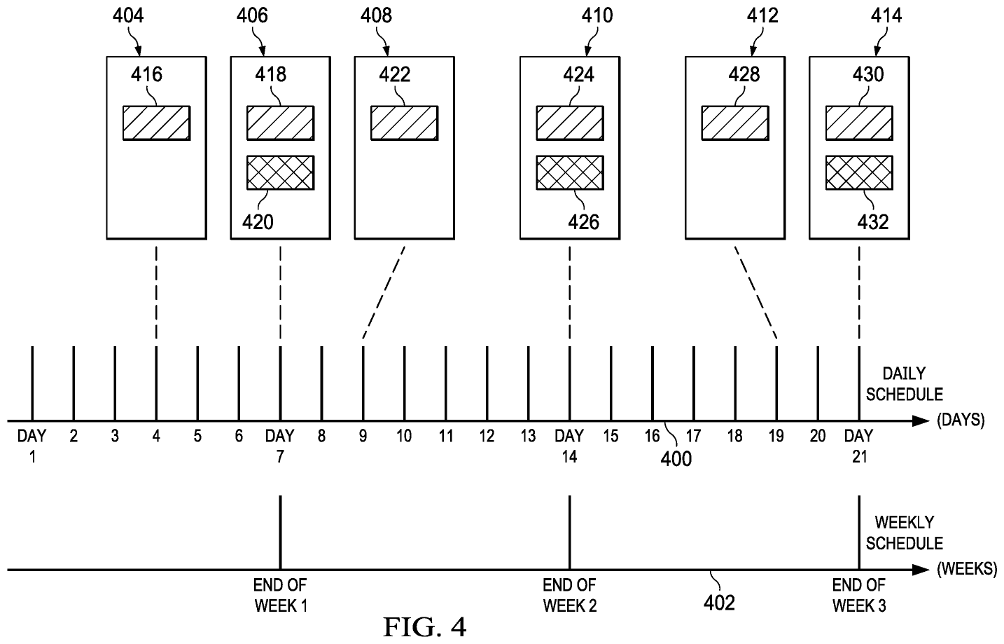

For example, base schedule 305 may be a daily schedule and supplementary schedule 308 may be a weekly schedule. Image 316 may be a snapshot that is generated on the seventh day. Image 316 may either be automatically associated with base schedule 305 when generated or may be tagged with base tag 322 to indicate that image 316 is associated with base schedule 305. Additionally, image 316 may be tagged with supplementary tag 324 of set of supplementary tags 320 that corresponds to supplementary schedule 308 to indicate that image 316 is also associated with the supplementary schedule 308. An example of how images (snapshots) may be tagged to designate such images for different schedules is described in greater detail in FIG. 4 further below.

In one or more embodiments, scheduler 300 maintains and stores set of tags 318 using data store 325. Data store 325 may include, for example, a database, a file, and/or some other way of tracking set of tags 318 for image 318. Data store 325 may be used to store all the various tags that are generated and associated with images 310. For example, supplementary tag 324 may be stored in data store 325 in association with an identifier for image 316.

In one or more embodiments, images 310 that are generated may be stored on node 302. In other embodiments, images 310 may be stored outside of node 302. For example, in some cases, images 310 may be stored remote to storage platform 301. In one or more embodiments, images 310 may be sent to and stored on cloud platform 326 outside of storage platform 301 via one or more communications links (e.g., wireless and/or wired communications links) (e.g., such as over network 126 in FIG. 1). Cloud platform 326 may be one example of an implementation for cloud platform 142 in FIG. 1. Cloud platform 326 may be in communication with controller 303 and/or scheduler 300. In some cases, scheduler 300 maintains at least a portion of data store 325 on cloud platform 326.

Images may be sent to and/or stored on cloud platform 326 on a rolling basis. For example, controller 303 of node 302 may store images on cloud platform 326 after some selected number of images has been generated, after a selected number of images has been generated within a selected period of time, after the lapse of a timer, or after some other predetermined event has occurred.

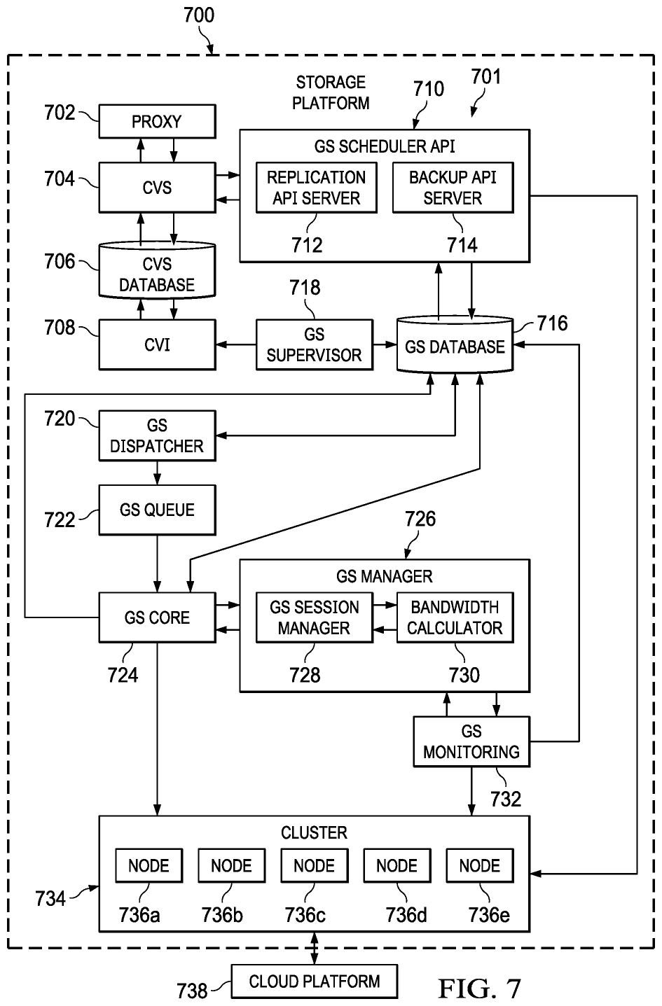

With reference still to FIG. 3, in some embodiments, at least a portion of scheduler 300 operates outside of node 302, for example, as or as part of a global scheduler. The global scheduler may manage and maintain images and tags for the set of supplementary schedules 306, while the portion of scheduler 300 operating within node 302 (e.g., within controller 303) may manage and maintain images and tags for the base schedule 305. In one or more embodiments, the global scheduler generates all images 310 based on base schedule 305 managed by the portion of scheduler 300 operating within node 302, with this portion then maintaining the corresponding base tags. The global scheduler maintains the corresponding supplementary tags for the set of supplementary schedules 306. The global scheduler may be implemented, for example, as described in U.S. patent application Ser. No. 17/588,901, entitled “Detached Global Scheduler,” filed Jan. 31, 202, which is incorporated herein by reference in its entirety. An example of how the global scheduler (e.g., global scheduler 701) may be implemented is described below in further detail with respect to FIG. 7.

The global scheduler, which may be scheduler 300 or may include at least a portion of scheduler 300, may manage scheduled and on-demand jobs, or tasks, including at least disaster recovery, cross region replication (and replication more generally), and backup jobs. The global scheduler exists within the storage platform 301 but outside of the nodes and optionally, outside of the clusters. By residing outside of the storage nodes, the global scheduler can have a holistic (i.e., global) view of the system and the resources available including on each storage node (e.g., node 302).

The global scheduler, which may be scheduler 300 or may include at least a portion of scheduler 300, may be used to manage set of supplementary schedules 306 for one or more users or customers. Thus, the storage operating system of storage platform 301 would not have to manage the supplementary schedules for multiple users working across different nodes or combinations of nodes across one or more clusters. The global scheduler 206 may be responsible for the lifecycle management of all the image generation (snapshot) jobs across storage platform 301 and may maintain a holistic view of all these jobs across the various nodes and clusters of storage platform 301. This includes being able to prioritize services based on different types of schedules, manage bandwidth for on-demand initialize jobs, and allow preemption.

FIG. 4 is a schematic diagram of snapshots associated with different periodic schedules in accordance with one or more example embodiments. Scheduler 300 described above with respect to FIG. 3 may be used to generate snapshots according to a daily schedule 400 and according to a weekly schedule 402 illustrated in FIG. 4. Daily schedule 400 is one example of an implementation for base schedule 305 described above with respect to FIG. 3. Daily schedule 400 is associated with a time interval of one day (e.g., 24 hours), which may be one example of an implementation for base interval 307 described above with respect to FIG. 3. Weekly schedule 402 is one example of an implementation for supplementary schedule 308 described above with respect to FIG. 3. Weekly schedule 402 is associated with a time interval of one week (e.g., 7 days), which may be one example of an implementation for supplementary interval 309 described above with respect to FIG. 3.

With respect to the daily schedule 400, scheduler 300 generates an image (or snapshot) daily (e.g., on day 1, day 2, day 3, day 4, day 5, day 6, day 7, etc.). In one or more embodiments, scheduler 300 generates each image at the same time each day. For example, images may be generated at the same hour of every day, at the same hour and minute every day, or at the same hour, minute, and second every day. As one non-limiting example, the time for image generation may be determined to be 5:00a.m. daily (with respect to a selected time zone). Scheduler 300 may generate the image at 5:00 am daily within selected tolerances. The selected tolerances may be, for example, within a certain number of minutes, seconds, milliseconds, microseconds, or nanoseconds or 5:00a.m. This number may be, for example, but is not limited to, 1, 2, 3, 4, 5, 6, 7, 8, 9, 10, 11, 12, 13, 14, 15, 20, 25, or other number. For example, scheduler 300 may generate images within 25 nanoseconds before or after 5:00a.m. daily.

As illustrated in FIG. 4, in one or more examples, image 404 is generated on Day 4; image 406 is generated on Day 7, image 408 is generated on Day 9, image 410 is generated on Day 14, image 412 is generated on Day 19, and image 414 is generated on Day 21. These images are examples of the various images generated by scheduler 300 for daily schedule 400. Further, image 404, image 406, image 408, image 410, image 412, and image 414 may each be an example of an implementation for one of images 310 (e.g., image 316) described above with respect to FIG. 3.

As illustrated in FIG. 4, image 404 is tagged with a metadata tag 416 that associates image 404 with daily schedule 400 and designates image 404 for use as the daily snapshot for Day 4. Metadata tag 416 is one example of an implementation for base tag 322 in FIG. 3 that has been associated with an image. Metadata tag 416 is an example of how such a tag can be associated with an image similar to how set of tags 318 is associated with image 316 in FIG. 3.

Image 406 is generated on Day 7. Image 406 is similarly tagged with a metadata tag 418 that associates image 408 with daily schedule 400 and designates image 406 for use as the daily snapshot for Day 7. Metadata tag 418 is another example of an implementation for base tag 322 in FIG. 3. Because Day 7 aligns with the end of Week 1, another metadata tag 420 is added to image 406. Metadata tag 420 further associates image 406 with the weekly schedule 402 and designates that image 406 be used as the weekly snapshot for Week 1. Metadata tag 420 is one example of an implementation for a supplementary tag 324 of set of supplementary tags 322 in FIG. 3. Together, metadata tag 418 and metadata tag 420 are another example of how such tags can be associated with an image similar to how set of tags 318 that is associated with image 316 in FIG. 3.

Restoring or recovering the data represented by the weekly snapshot for Week 1 includes computing the set of deltas between each respective pair of preceding images in the week of images. For example, to recover the data for Week 1, a delta (e.g., difference) is computed between image 406 of Day 7 and the image of Day 6; a delta is computed between the image of Day 6 and the image of Day 5; a delta is computed between the image of Day 5 and the image 404 of Day 4; a delta is computed between image 404 of Day 4 and the image of Day 3; a delta is computed between the image of Day 3 and the image of Day 2; and a delta is computed between the image of Day 2 and the image of Day 1. These six deltas determine the overall delta between image 406 at Day 7 and the initial image generated for Day 1.

By using image 406 as both the daily snapshot for Day 7 and the weekly snapshot for Week 1, the overall computing resources (e.g., storage, memory, processing power, etc.) that would otherwise be required to store and maintain all of the images between and including Day 1 and Day 7 as well as a separate image capturing all of the metadata pointing to the blocks stored on the volume for the entire Week 1.

Image 408 includes metadata tag 422 that associates image 408 with daily schedule 400 and designates image 408 for use as the daily snapshot for Day 9. Image 410 includes metadata tag 424 that associates image 410 with daily schedule 400 and designates image 410 for use as the daily snapshot for Day 14. Image 410 further includes metadata tag 426 that associate image 410 with weekly schedule 402 and designates image 410 for use as the weekly snapshot for Week 2. Image 412 includes metadata tag 428 that associates image 412 with daily schedule 400 and designates image 412 for use as the daily snapshot for Day 19. Image 414 includes metadata tag 430 that associates image 414 with daily schedule 400 and designates image 414 for use as the daily snapshot for Day 21. Image 414 further includes metadata tag 432 that associates image 414 with weekly schedule 402 and designates image 414 for use as the weekly snapshot for Week 3.

Restoring or recovering the data represented by the weekly snapshot for a given week includes computing the set of deltas between each respective pair of preceding images in that week of images. For example, to recover the data for Week 2, the various deltas are computed between image 410 of Day 14 and image 406 of Day 7. As another example, to recover the data for Week 3, the various deltas are computed between image 414 of Day 21 and image 410 of Day 14.

By using image 410 as both the daily snapshot for Day 14 and the weekly snapshot for Week 2, the overall computing resources (e.g., storage, memory, processing power, etc.) that would otherwise be required to store and maintain all of the images between and including Day 8 and Day 14 as well as a separate image capturing all of the metadata pointing to the blocks stored on the volume for the entire Week 2. Similarly, by using image 414 as both the daily snapshot for Day 21 and the weekly snapshot for Week 3, the overall computing resources (e.g., storage, memory, processing power, etc.) that would otherwise be required to store and maintain all of the images between and including Day 15 and Day 21 as well as a separate image capturing all of the metadata pointing to the blocks stored on the volume for the entire Week 3.

The images 404, 406, 408, 410, 412, and 414 may be tagged with the corresponding ones of tags (i.e., tags 416, 418, 420, 422, 424, 426, 428, 430, and 432) by being associated with the tags. For example, image 404 may be associated with metadata tag 416 by having its identifier linked to metadata tag 416 in a database, a file, or some other type of data store (e.g., data store 325 in FIG. 3). Similarly, metadata tag 418 and metadata tag 420 may both be associated with the identifier for image 406 such that image 406 is considered “tagged.”

### IV. Example Methodologies for Generating and Managing Snapshots

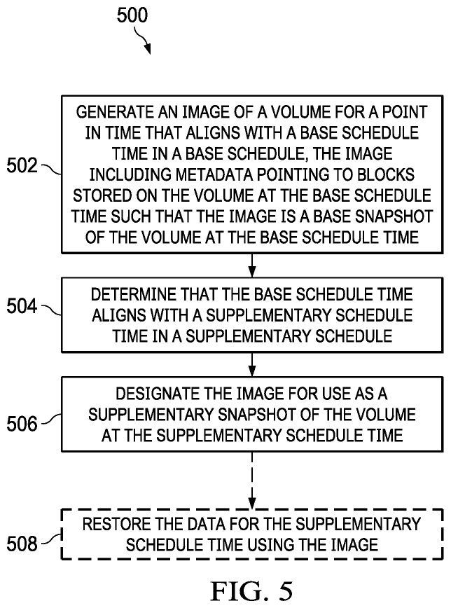

FIG. 5 is a flow diagram of a process 500 for managing snapshots according to different periodic schedules in accordance with one or more example embodiments. Managing snapshots includes generating and maintaining snapshots. Process 500 may be implemented by one or more processors executing computer-readable instructions (e.g., from one or more computer-readable media) to perform the functions described herein. Process 500 may be implemented using one or more processors in a node in a cluster such as, for example, first node 130, second node 132, or third node 134 in FIG. 1. In some cases, process 500 may be implemented by one or more processors of a data storage apparatus, such as, for example, one of the data storage apparatuses 202(1)-202(n) described in connection with FIG. 2. In one or more embodiments, process 500 may be implemented by one or more processors of a node such as, for example, node 302 in FIG. 3. In one or more embodiments, process 500 may be implemented by scheduler 300 of storage platform 301 in FIG. 3.

Operation 502 includes generating an image of a volume for a point in time that aligns with a base schedule time in a base schedule, the image including metadata pointing to data blocks stored on the volume at the base schedule time such that the image is a base snapshot of the volume at the base schedule time. The image may be, for example, a read-only, point-in-time image of the volume that includes metadata pointing to the blocks of data stored on the volume. In one or more embodiments, the image is considered automatically associated with the base schedule upon creation. In other embodiments, the image is designated for use as the base schedule snapshot using, for example, a metadata tag. The base schedule may be, for example, base schedule 305 in FIG. 3. In some cases, the base schedule is a periodic schedule for generating snapshots regularly according to a selected time interval (base interval) or regular frequency. In other cases, the base schedule includes a plurality of base schedule times that occur regularly or irregularly over time. These base schedule times may be, for example, defined by one or more users and/or processes.

Operation 504 includes determining that the base schedule time aligns with a supplementary schedule time in a supplementary schedule. The supplementary schedule may be, for example, a supplementary schedule (e.g., supplementary schedule 308) in set of supplementary schedules 306 in FIG. 3. Operation 504 may be performed using, for example, a timestamp associated with the image.

In one or more embodiments, the supplementary schedule includes a plurality of supplementary schedule times (points in time) that align with the base schedule. In other words, each scheduled time (or supplementary schedule time) in the supplementary schedule may align with (or fall on, coincide with, etc., within tolerances) a corresponding scheduled time (or base schedule time) in the base schedule.

In one or more embodiments, the base schedule comprises a series of base schedule times that recur with respect to a base interval. Further, an interval between a first supplementary schedule time and a second supplementary schedule time (that is immediately preceding) may be a multiple of the base interval. The multiple may be greater than one. In some examples, the supplementary schedule comprises a series of supplementary schedule times that recur with respect to a supplementary interval that is a multiple of the base interval. This multiple may be greater than one.

In one or more embodiments, the base schedule includes a series of base schedule times that occur at a first frequency and the supplementary schedule includes a series of supplementary schedule times that occur at a second frequency. The second frequency may be lower than the first frequency such that the base schedule times occur more often than the supplementary schedule times.

In some cases, the base schedule is periodic and includes a series of base schedule times that recur with respect to a base interval in which the base interval is one minute, two minutes, five minutes, ten minutes, thirty minutes, one hour, two hours, four hours, six hours, twelve hours, one day, two days, three days, four days, five days, six days, one week, ten days, two weeks, one half of a month, one month, two months, one quarter of a year, one half of a year, or one year. In some cases, the supplementary schedule is periodic and includes a series of supplementary schedule times that recur with respect to a supplementary interval in which the supplementary interval is two minutes, five minutes, ten minutes, thirty minutes, one hour, two hours, four hours, six hours, twelve hours, one day, two days, three days, four days, five days, six days, one week, ten days, two weeks, one half of a month, one month, two months, one quarter of a year, one half of a year, or one year. In one or more embodiments, the base schedule is a daily schedule, and the supplementary schedule is a weekly schedule, bi-weekly schedule, a monthly schedule, a bi-monthly schedule, a quarterly schedule, a yearly schedule, or some other type of periodic schedule.

Process 500 further includes operation 506, which includes designating the image for use as a supplementary snapshot of the volume at the supplementary schedule time. In one or more embodiments, designating the image for use as the supplementary snapshot includes tagging the image with a metadata tag. For example, metadata may be added to the image indicating that it is to be used as the snapshot (supplementary snapshot) for the supplementary schedule time. In this manner, designating an image for use as a snapshot may include tagging the image with a metadata tag to indicate this use.

In other embodiments, other types of operations may be used to designate an image for use as a snapshot for the supplementary schedule. For example, an index associated with the image may be recorded in a table. The table may be used to track the indexes of all images generated. The table may include information (e.g., tags, labels, etc.) that indicate when the image is to be used for the supplementary schedule in addition to the base schedule.

The image can thus be used to restore the state of the data on the volume at the supplementary schedule time. Restoration of this data corresponding to the supplementary schedule time includes computing a plurality of deltas between a plurality of base snapshots, which includes the base snapshot described above, created between the supplementary schedule time and an immediately preceding supplementary schedule time in the supplementary schedule. In this manner, the overall computing resources, including storage capacity, memory, and processing power, which is needed for generating and maintaining snapshots may be reduced because one image (or snapshot) can be designated for use across multiple schedules and when restoration of data is requested, the deltas can be computed as described above on-demand.

In one or more embodiments, process 500 may optionally operation 508, which includes restoring the data for the supplementary schedule time using the image. For example, the plurality of deltas between all the base snapshots created between the supplementary schedule time and an immediately preceding supplementary schedule time in the supplementary schedule are computed. These deltas together capture all of the changes to the data between the supplementary schedule time and the immediately preceding supplementary schedule time in the supplementary schedule.

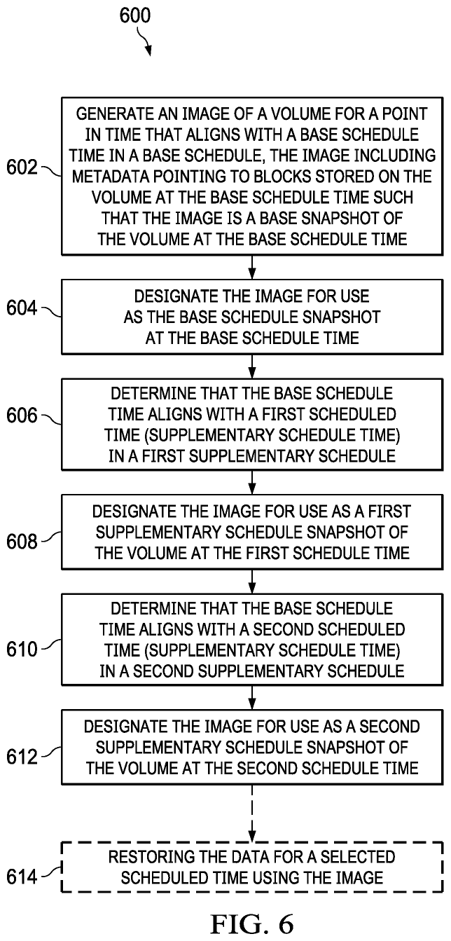

FIG. 6 is a flow diagram of a process 600 for managing snapshots according to different periodic schedules in accordance with one or more example embodiments. Managing snapshots includes generating and maintaining snapshots. Process 600 may be implemented by one or more processors executing computer-readable instructions (e.g., from one or more computer-readable media) to perform the functions described herein. Process 600 may be implemented using one or more processors in a node in a cluster such as, for example, first node 130, second node 132, or third node 134 in FIG. 1. In some cases, process 600 may be implemented by one or more processors of a data storage apparatus, such as, for example, one of the data storage apparatuses 202(1)-202(n) described in connection with FIG. 2. In one or more embodiments, process 600 may be implemented by one or more processors of a node such as, for example, node 302 in FIG. 3. In one or more embodiments, process 600 may be implemented by scheduler 300 of storage platform 301 in FIG. 3. Process 600 may be one example of an implementation for process 500 in FIG. 5.

Operation 602 includes generating an image of a volume for a point in time that aligns with a base schedule time in a base schedule, the image including metadata pointing to data blocks stored on the volume at the base schedule time such that the image is a base snapshot of the volume at the base schedule time. The image may be, for example, a read-only, point-in-time image of the volume that includes metadata pointing to the blocks of data stored on the volume.

Operation 604 includes designating the image for use as the base schedule snapshot at the base schedule time. Operation 604 may be performed using, for example, a metadata tag. The base schedule may be, for example, base schedule 305 in FIG. 3. In some cases, the base schedule is a periodic schedule for generating snapshots regularly according to a selected time interval (base interval) or regular frequency. In other cases, the base schedule includes a plurality of base schedule times that occur regularly or irregularly over time. These base schedule times may be, for example, defined by one or more users and/or processes.

Operation 606 includes determining that the base schedule time aligns with a first scheduled time (supplementary schedule time) in a first supplementary schedule. The first supplementary schedule is one example of an implementation for a supplementary schedule (e.g., supplementary schedule 308 in set of supplementary schedules 306 in FIG. 3. Operation 604 may be performed using, for example, a timestamp associated with the image.

Operation 608 includes designating the image for use as a first supplementary schedule snapshot of the volume at the first schedule time. Operation 608 may be performed by, for example, tagging the image with a metadata tag. Restoration of data with respect to the first scheduled time includes computing the plurality of deltas between a plurality of base snapshots, which includes the base snapshot described above, created between the first schedule time and an immediately preceding scheduled time in the first supplementary schedule.

Operation 610 includes determining that the base schedule time aligns with a second scheduled time (supplementary schedule time) in a second supplementary schedule. The second supplementary schedule is one example of an implementation for a supplementary schedule (e.g., supplementary schedule 308 in set of supplementary schedules 306 in FIG. 3.

Operation 612 includes designating the image for use as a second supplementary schedule snapshot of the volume at the second schedule time. Operation 608 may be performed by, for example, tagging the image with a metadata tag. Restoration of data with respect to the second scheduled time includes computing the plurality of deltas between a plurality of base snapshots, which includes the base snapshot described above, created between the second schedule time and an immediately preceding scheduled time in the second supplementary schedule.

In this manner, the overall computing resources, including storage capacity, memory, and processing power, which is needed for generating and maintaining snapshots may be reduced because one image (or snapshot) can be designated for use across multiple schedules and when restoration of data is requested, the deltas can be computed as described above on-demand.

In one or more embodiments, each of the first supplementary schedule and the second supplementary schedule includes a plurality of supplementary schedule times (points in time) that align with the base schedule. In other words, each scheduled time (or supplementary schedule time) in the two supplementary schedules aligns with (or falls on, coincides with, etc., within tolerances) a corresponding scheduled time (or base schedule time) in the base schedule.

In one or more embodiments, the base schedule includes a series of base schedule times that occur at a first frequency and each of the first supplementary schedule and/or the second supplementary schedule includes a series of supplementary schedule times that occur at a second frequency. The second frequency may be lower than the first frequency such that the base schedule times occur more often than the supplementary schedule times.

In some cases, the base schedule is periodic and includes a series of base schedule times that recur with respect to a base interval in which the base interval is one minute, two minutes, five minutes, ten minutes, thirty minutes, one hour, two hours, four hours, six hours, twelve hours, one day, two days, three days, four days, five days, six days, one week, ten days, two weeks, one half of a month, one month, two months, one quarter of a year, one half of a year, or one year. In some cases, the first supplementary schedule and/or the first supplementary schedule is periodic and includes a series of supplementary schedule times that recur with respect to a supplementary interval in which the supplementary interval is two minutes, five minutes, ten minutes, thirty minutes, one hour, two hours, four hours, six hours, twelve hours, one day, two days, three days, four days, five days, six days, one week, ten days, two weeks, one half of a month, one month, two months, one quarter of a year, one half of a year, or one year. In one or more embodiments, the base schedule is a daily schedule, and the supplementary schedule is a weekly schedule, bi-weekly schedule, a monthly schedule, a bi-monthly schedule, a quarterly schedule, a yearly schedule, or some other type of periodic schedule.

In one or more embodiments, process 600 may optionally include operation 614, which includes restoring the data for a selected scheduled time using the image, wherein the selected scheduled time is the first scheduled time or the second scheduled time. For example, for the first scheduled time in the first supplementary schedule, the plurality of deltas is computed between all the base snapshots created between the first scheduled time and an immediately preceding scheduled time in the first supplementary schedule. These deltas together capture all the changes to the data between the first scheduled time and the immediately preceding scheduled time in the first supplementary schedule. As another example, for the second scheduled time in the second supplementary schedule, the plurality of deltas is computed between all the base snapshots created between the second scheduled time and an immediately preceding scheduled time in the second supplementary schedule. These deltas together capture all the changes to the data between the second scheduled time and the immediately preceding scheduled time in the second supplementary schedule.

### V. Example of Global Scheduler

Turning now to FIG. 7, details of a storage platform 700 are illustrated according to embodiments of the present disclosure. The storage platform 700 may be one example of an implementation for storage platform 140 in FIG. 1, storage platform 201 in FIG. 2, and/or storage platform 301 in FIG. 3. The storage platform 700 includes a global scheduler 701 as multiple individual services working together to perform the functions of the global scheduler. This global scheduler 701 may be one example of an implementation for scheduler 300 in FIG. 3. In some embodiments, the global scheduler 701 may include scheduler 300 operating within it. Separating the functions of the global scheduler 701 into multiple services allows the global scheduler to be more easily extensible. The storage platform 700 may be a back-end storage service for a cloud system. The cloud system may communicate with the storage platform 700 through a proxy 702. Generally, the proxy 702 may provide one or more APIs for a cloud system to communicate with global scheduler 701 of the storage platform 700. The proxy 702 may communicate with a cloud volume service (CVS) 704. The CVS 704 may store information in a CVS database 706.

As described above, the global scheduler 701 may include multiple independent services working in cooperation to perform the function of the global scheduler 701. As illustrated in FIG. 7, such services can include a global scheduler (GS) scheduler API 710, which includes a replication API server 712 and a backup API server 714; a GS database 716; a GS supervisor 718; a GS dispatcher 720; a GS queue 722; a GS core 724; a GS manager 726 including a GS session manager 728 and a bandwidth calculator 730; and a GS monitoring service 732. These services combined may be collectively referred to as the global scheduler 701. In one or more embodiments, each of the services that make up the global scheduler 701 may be running in a containerized environment, such as, for example, a Kubernetes® cluster, though other containerized environments are contemplated. In some examples, each service of the storage platform 700 may be running in a separate container that is deployed within a cluster. In some other examples, multiple components of the storage platform 700 may be running in the same container.

This logical structure provides several benefits such as the inter-operation of the components allows for more functions, and flexibility, to be achieved. The separation of the services to different components that interact together makes the system overall more manageable and more easily extendable (e.g., starting with providing replication service, then expanding to backups and other types of scheduling, such as rekey and other schedule-based services).

The global scheduler 701, including these cooperating components, communicates with a cluster 734. The cluster 734 may be an example of a cluster described above with respect to FIGS. 1-2 (e.g., a first cluster 136, a second cluster 138, etc.). While a single cluster, cluster 734, is illustrated for simplicity of discussion, there may be more than one cluster. Each cluster represented by cluster 734 may be in the same region or may be in different regions. Cluster 734 may include one or more storage nodes 736. As illustrated in FIG. 7, cluster 734 includes storage nodes 736a, 736b, 736c, 736d, and 736e.

The global scheduler 701 may manage the scheduling and tagging of snapshots for cluster 734. For example, the global scheduler 701 may direct the nodes 736a, 736b, 736c, 736d, and 736e of cluster 734 with respect to when to generate snapshots. In one or more embodiments, the global scheduler 701 generates tags for the snapshots to associate the snapshots with one or more schedules. In some embodiments, the global scheduler 701 generates tags to associate certain snapshots with a supplementary schedule (e.g., a schedule similar to supplementary schedule 308 described with respect to FIG. 3) and/or a base schedule (e.g., a base schedule similar to base schedule 305 described with respect to FIG. 3). The global scheduler 701 may manage these tags in a data store (e.g., a database, a file, etc.) in association with identifiers for the snapshots. In one or more embodiments, at some point in time after generation (e.g., after a certain number of snapshots have been created, after a certain number of snapshots have been created in a certain amount of time, etc.) the snapshots may be sent to a remote location. For example, snapshots may be stored on cloud platform 738. Cloud platform 738 may include cloud storage. The global scheduler 701 and/or at least a portion of the cluster 734 may be in communication with the cloud platform 738.

As previously discussed, customers communicate with the storage platform 700 through proxy 702. Proxy 702 provides an interface between customers and CVS 704. CVS 704 may provide an API for requesting replication of volumes stored on storage nodes 736a-336e. CVS 704 may also provide an API for requesting replication of volumes, backups of volumes, and performing other operations within storage platform 700 that may be scheduled and run by the global scheduler 701. As an example, CVS 704 may provide an API for creating replication relationships for volumes stored in cluster 734 on one of the nodes 736a-336b. The replication relationship may be stored in the CVS database 706. The CVS database 706 may maintain, among other information, jobs created by customers 104, 105. The jobs may be volume replication, volume backup, node rekey, and/or other jobs. The CVI 708 may communicate with the CVS 704, and more specifically with the CVS database 708, to provide additional information to the global scheduler 701, as will be discussed further below.

The CVS 704 may communicate with the GS scheduler API 710 to create a scheduled job. The GS scheduler API 710 may include one or more different API servers to handle the different requests from the CVS 704. For example, the replication API server 712 may provide an endpoint for volume replication requests. The requests received by the replication API server 712 may be stored in the GS database 716 along with pertinent scheduling information such as, for example, frequency and priority. As another example, the backup API server 714 may provide an endpoint for volume backup requests. The volume backup requests received by the backup API server 714 may also be stored in the GS database 716 and include pertinent scheduling information for volume backups. Although only two servers are illustrated, other API servers to handle other request types (e.g., encryption rekey) are contemplated for use with the global scheduler 701. The GS scheduler API 710 may communicate with the cluster 734, and more specifically with one of the nodes 736a-336e within the cluster 734. In some examples, the GS scheduler API 710 may query volume details from the node 736a-336e on which the volume is stored. These details may then be stored in the GS database 716. The data stored in the GS database 716 may be used as a persistent backup if any of the global scheduler services restart.

The GS database 716 may run on a SQL database, such as for example, MySQL, Oracle SQL, PostgreSQL, etc. In other examples, the database 716 may run a NoSQL database, such as for example, MongoDB, DynamoDB, etc. The GS database 716 may store, among other information, job schedules, job status, and job history. This information may be used to achieve the targeted customer fairness by tracking the history and status of jobs to ensure that each customer is receiving the contracted level of service. For example, a lower priority job may not run as scheduled because it is lower priority than other jobs, there are not enough resources to run the lower priority job, the lower priority job is preempted, just to name a few examples. The GS database 716 may store a record of each time that the lower priority job is skipped or otherwise is not run as scheduled. These records may be used to ensure that the lower priority job runs at least once over a predetermined period of time (e.g., 10 minutes, 1 hour, 1 day, etc.) regardless of the priority of the lower priority job. If it is determined that the lower priority job has not run for the given period of time, or threshold period of time, then the job may be scheduled before a higher priority job. This promotes customer fairness and ensures that each customer is receiving the contracted level of service.

The GS supervisor 718 may keep metadata in sync between the CVS database 706 and the GS database 716. The metadata may include node, host, and storage virtual machine details, including, for example, source, location, bandwidth, number of sessions (e.g., SnapMirror), etc. The GS supervisor 718 may also handle requests for updating customer and global configuration parameters including, for example, maximum number of sessions available for each job type, percentage of sessions used for each job type, schedule session thresholds, bandwidth, etc. Session thresholds may define a minimum number of sessions that must be available for each job type. The GS supervisor 718 may periodically poll data from the CVI 708 to update the GS database 716. In some examples, the GS supervisor 718 may poll the CVI 708 based on a schedule. In some other examples, the GS supervisor 718 may poll the CVI 708 based on a trigger, such as for example, the creation of a new volume by the CVS 704. The GS supervisor 718 may populate the host, SVM, and node (and/or other) details in the GS database 716 before a job is triggered.

The GS dispatcher 720 may query the GS database 716 for eligible jobs and creating a pipeline for each type of job for each node 736a-336e. For example, the GS dispatcher 720 may create a first pipeline, or series of jobs, for replication jobs and a second pipeline for backup jobs. The GS dispatcher may then publish the job pipelines to the GS queues 722. Each job pipeline may be published to its own queue in the GS queues 722. For example, the replication job pipeline may be published to the replication job queue and the backup job pipeline may be published to the backup job queue. Other job queues may be created for different types of scheduled jobs. In other examples, some jobs may be published to the same queue, such that a given queue may have one or more job types (and/or multiple nodes), with multiple queues in total, while in other examples each job type may have its own queue.

On startup, the GS dispatcher 720 may scan the GS database 716 for scheduled backup jobs and replication jobs. In some embodiments, the GS dispatcher 720 may store the metadata for the jobs in its own local storage, such as, for example, a job metadata cache. After startup, the GS dispatcher 720 may periodically rescan the GS database 716 and update its job metadata cache. Maintaining a local, cached copy of the scheduled jobs may improve the speed of the GS dispatcher 720 by removing potentially costly communication with the GS database 716. The GS dispatcher 720 may use the metadata stored in its job metadata cache to build the job pipelines. In building the pipelines, the GS dispatcher 720 may determine the priority of each job based at least in part on the schedule (e.g., hourly, daily, etc.) and the lag time of the job (e.g., how far behind schedule the job is currently). In some embodiments, the GS dispatcher 720 may build a separate pipeline for each node 736a-336e. After building the job pipelines, the GS dispatcher 720 may determine whether each pipeline can be published. In some embodiments, the determination is made in a round-robin manner based on node. In some other embodiments, the determination is made in a round-robin manner based on job type.

The GS queues 722 maintain job queues of the job pipelines created by the GS dispatcher 720. The job queues may include scheduled backup jobs, volume replication jobs, and on-demand backup jobs (to name a few examples). The job queues stored by GS queues 722 may be ready to be processed upon request by another service, such as for example, the GS core 724 service. In some embodiments, the job queues stored in the GS queues 722 may be implemented using RabbitMQ. In some embodiments, the job queues stored in the GS queues 722 may be shared with other services in the cluster. In some other embodiments, each service within the cluster, including GS queues 722, may have their own job queues. In some examples, the other services may not be part of the global scheduler services.

The GS core 724 may select and prepare the individual jobs that are stored by the job queues of the GS queues 722. These jobs include jobs stored in the scheduled backup job queue, the volume replication job queue, and the on-demand job queue, among others (where there are more). The GS core 724 may follow a process of de-queueing a job, determining whether there are sufficient resources to run the job, and running the job. To begin the dequeue process, the GS core 724 may receive a message from the GS queues 722, specifically from a job queue such as the volume replication queue within the GS queues 722. The GS core 724 may then determine whether the job may be run on the node 736a-336e. Determining whether the job may be run may include determining whether there are sufficient sessions on the node 736a-336e, identified by the job, to run the job. If the job is ready to be run on the node 736a-336e, the GS core 724 may take ownership of the job and send an acknowledge message to the GS queues 722 to remove the message from the queue. Alternatively, if the job cannot be run on node 736a-336e, the job may be marked for a later cycle and an acknowledge message sent to the GS queues 722 to remove the message from the queue. In such a case, the GS dispatcher 720 may, at a future time, re-publish the job to ensure that the job is scheduled fairly. A lag time is calculated for the job that is removed where the lag time is the difference between the current time and the scheduled time. The lag time is then compared to a threshold time period to determine when the job cannot be rescheduled and must be run. This threshold time period may be measured in minutes, hours, or days. The job may be skipped again when the lag time is less than the threshold period of time. The job is not skipped when the lag time is greater than the threshold period of time. Tracking the lag time ensures that the jobs are scheduled fairly. Alternatively, the GS core 724 may use job preemption and network bandwidth adjustments to run a job instead of marking the job for a later cycle.

For example, if there are insufficient sessions to run the current job, the GS core 724 may determine if it is possible to preempt a lower priority running job. Job preemption may be limited to occur in situations where the job count is more than a minimum threshold for that job type. To identify an optimal candidate for a preemption, the GS core 724 may scan from the lowest priority running job to that with a priority level closest to, but less than, the dequeued (not yet running) job. If a candidate is found, the GS core 724 may pause that candidate (running) job and run the dequeued job in its place. In some alternative examples, a lower priority job may preempt a higher priority if it the higher priority job is underutilizing its resources. Where a preemption candidate is unavailable, the GS core 724 may attempt to adjust the network bandwidth of running jobs to make them complete sooner, as described next.

If the dequeued job is a high priority job and a preemption candidate is not available, the GS core 724 may try to adjust the bandwidth of running jobs to make a selected job complete sooner so as to release and make available the sessions of the selected job earlier. This is done by reducing the bandwidth of one job and transferring that bandwidth to the selected, running job that the GS core 724 has determined to complete sooner. To identify the candidate jobs to increase and decrease the bandwidth, the GS core 724 may consider the running duration of the job, the transferred size of the job, the total transfer size of the job, average completion time of the job based on historic data, and/or the current transfer rate of the job, among other parameters. In some examples, user-initiated jobs (e.g., backup, restore, etc.) may be serviced at the highest priority.

GS core 724 may use a type of attribute associated with a job to distinguish the various job types available. Based on the job type the GS core 724 may spawn a corresponding worker (e.g., process, thread, etc.) for the job. Some examples of workers are ad-hoc workers, scheduled workers, restore workers, and replication workers. The ad-hoc workers may run on-demand backup jobs. The scheduled workers may run backup jobs that are scheduled. The restore workers may run on-demand restore jobs for a backup. The replication worker may run a replication job.

The GS manager 726 may include the GS session manager 728 and the bandwidth calculator 730. On startup, the GS session manager 728 may read job information from the GS database 716 to build an initial job status session cache. Subsequently, this cache may be updated by messages from the GS monitoring service 732.

The GS session manager 728 may maintain a list of free and in-use sessions for each node 736a-336e of the cluster 734. In some examples, the sessions may be SnapMirror sessions. Once peering has been established between the source and a destination, the CVS 704 may create a SnapMirror relationship (following this example) for source and destination volumes. After the relationship has been created, volume replication jobs may be triggered. In order to run a volume replication job, both source and destination nodes 736a-336e may have their session availability count decreased by one because both nodes have allocated a session to run the volume replication job. A single node from among nodes 736a-336e may support a limited number of active sessions at any point in time. In some embodiments, the number of active sessions may be based on the number of hosted volumes. For example, a node that hosts 1000 volumes may be limited to 100 active sessions at any point in time (as just one numeric example). This limit may ensure that the core data access duties of the storage platform 700 are not interrupted by the GS core 724 running jobs.

The GS session manager 728 may use configurable parameters such as sessions per node, preemption enabled, and session manager rules, among others. For example, a user may disable preemption. As another example, the GS session manager 728 may maintain a maximum number of sessions (e.g., SnapMirror sessions) per node 736a-336e. While a maximum of about 100 sessions is given for sake of illustration, the maximum may be higher or lower. In some examples, the maximum number of sessions may be determined based on the total number of volumes stored on the node 736a-336e. For example, the maximum number of active sessions may be set at a percentage of the total number of volumes (e.g., 10%), meaning that if 1000 volumes are stored on the node 736a, then the node 736a may have 100 active sessions at any one time. This ensures that the core data transfer requirements of the storage platform 700 may be met.

The GS session manager 728 may have predefined rules for session assignment and may be at varying levels such as some at the global level as well as some at the customer level. These rules may be refreshed in the cache in case of any update operation. In some embodiments, the rules may correspond to the requirements of the jobs. For example, volume replication job rules may include a maximum number of initialize jobs running simultaneously at a global level, a maximum number of concurrent ad-hoc replication jobs at the customer level, and/or a maximum number of concurrent scheduled replication jobs at the customer level. As another example, backup job rules may include a maximum number of manual backup jobs per day at a customer level, a maximum number of restores per day at a customer level, and/or a maximum number of concurrent restore and manual backup jobs at a customer level.

The GS session manager 728 may maintain a fixed number of sessions (including both a free pool and an in-use pool) for each node 736a-336e. The sessions may be divided into a free pool and an in-use pool. Sessions in the free pool are available to be assigned while sessions in the in-use pool are currently running a job. The sessions in each pool may be further divided into an initialize pool and an update pool. The sessions in the initialize pool may be used for an initial job (e.g., replication, backup, etc.) that may transfer larger amounts of data and take a longer amount of time. The sessions in the update pool may be used for update jobs (e.g., replication, backup, etc.) where incremental changes are recorded, requiring less time and data transfer. The GS session manager 728 may provide an API interface for session assignment, including assignment and release operations. The GS monitoring 732 and the GS core 724 may use the API interface to assign and release sessions and to update the GS session manager 728 of any ongoing job progress. The GS session manager 728 may also maintain the job details associated with each session in use including, for example, percent complete, bandwidth used, and elapsed time. When the GS session manager 728 assigns a session to a node (e.g., node 736a), the GS session manager 728 moves the session from the free pool to the in-use pool for the node (e.g., node 736a). In some examples, bandwidth may be assigned to the node (e.g., 736a) at the same time as the session. When a job is completed, the GS monitoring service 732 may notify the GS session manager 728 to release the session and move it to the free pool.

The GS session manager 728 may further make session assignment determinations based on job information such as for example, priority, job type, job threshold, and job bandwidth, among others. Job types may include, for example, backup initialize, backup update, replication initialize, and replication update. For example, the GS session manager 728 may use a session from the initialize pool for an initialize job and use a session from the update pool for an update job. As another example, the GS session manager 728 may prioritize session assignment based on the scheduled duration of the job. That is, the GS session manager 728 may assign a session to a job estimated or scheduled to complete sooner than another (longer-duration) job, before assigning a session to the longer-duration job. In some examples, the GS session manager 728 may define a minimum threshold, or number, of running jobs for each job type to ensure that the different job types are being run. For example, a group of update jobs may be repeatedly scheduled before a group of scheduled initialize jobs because each of the update jobs has a higher priority than each of the initialize jobs. This may result in the initialize jobs not being run. Setting a minimum threshold of running jobs for each job type ensures that jobs of all job types are able to run in a timely manner. Furthermore, the GS session manager 728 may determine to not preempt a job of a job type because the number of jobs of that type currently running is less than the minimum threshold for that job type. The GS session manager 728 may communicate with the bandwidth calculator 730 to obtain (e.g., reserve) bandwidth for a job. The GS session manager 728 may provide the bandwidth to the GS core 724 when the session is assigned.

The bandwidth calculator 730 may keep track of available and used bandwidth for each node 736a-336e. When a job is assigned a session by the GS session manager 728, it may provide the bandwidth allocated together with the session. The allocated bandwidth may be based on configurable parameters, such as for example, total bandwidth and initial window size, among others. In some examples, update type jobs may be configured with unlimited bandwidth so that the nodes 736a-336e can evenly distribute the bandwidth upon availability in order to maximize resource utilization. In some other examples, initialize type jobs may use the bandwidth calculator 730. During startup and initialization, the bandwidth calculator 730 may begin with an initial window size (i.e., the maximum number of jobs that can be serviced at any given time). The window size may be dynamically adjusted later on based on the volume of jobs running and changes to the nodes (e.g., addition, removal, and/or failure of one or more nodes).

The bandwidth calculator 730 may determine bandwidth allocated to a job based on the job details provided by the GS session manager 728. Job details may include, for example, the type of job, the priority of the job, the customer ID, and the node UUID, among others. The amount of available bandwidth, and how much is allocated, may be based on each node 736a-336e individually. Therefore, as bandwidth is assigned to each job, the amount of available bandwidth for that node 736a-336e decreases. When a job completes and the GS session manager 728 releases the session, the bandwidth corresponding to that session is returned to the available bandwidth of the node 736a-336e. In some examples, the total number of jobs running may affect the available bandwidth.

The GS monitoring service 732 may be responsible for updating the job status of each job running under the direction of the global scheduler 701. To do this, the GS monitoring service 732 may periodically query the job status from all nodes 736a-336e running jobs. The GS monitoring service 732 may then update both the GS session manager 728 and the GS database 716 with the status of each job. During startup, the GS monitoring service 732 may obtain necessary node and host information (e.g., IP address, usernames, passwords, etc.) from the GS DB 716. The GS monitoring service 732 may refresh the data periodically to identify nodes that have been added, removed, and/or are unresponsive.

After initialization, the GS monitoring service 732 may periodically send messages to every node 736a-336e in the cluster 734 to query the status for every job on every node 736a-336e. The GS monitoring service 732 then sends a message to the GS session manager 728 indicating which nodes 736a-336e have a change in their job status. In some examples, this may trigger the GS session manager 728 to query the GS database 716 for any changes to the nodes 736a-336e. The GS monitoring service 732 may, at the same time, write the updated job status to the GS database 716.

Together, these various services interact to provide the functions of the global scheduler 701. Moreover, as previously noted, providing these services as different aspects that interact together enables the system overall to be more manageable and more easily extendable. The operations of these different services combine together to provide the cross-region and cross-cluster, holistic view into the overall operation of a system that was otherwise not available to schedulers with views limited to just the operating system in which they were located.

### VI. Additional Considerations

All examples and illustrative references are non-limiting and should not be used to limit the claims to specific implementations and examples described herein and their equivalents. For simplicity, reference numbers may be repeated between various examples. This repetition is for clarity only and does not dictate a relationship between the respective examples. Finally, in view of this disclosure, particular features described in relation to one aspect or example may be applied to other disclosed aspects or examples of the disclosure, even though not specifically shown in the drawings or described in the text.

The headers and subheaders between sections and subsections of this document are included solely for the purpose of improving readability and do not imply that features cannot be combined across sections and subsection. Accordingly, sections and subsections do not describe separate embodiments.

The terms and expressions which have been employed are used as terms of description and not of limitation, and there is no intention in the use of such terms and expressions of excluding any equivalents of the features shown and described or portions thereof, but it is recognized that various modifications are possible within the scope of what is claimed. Thus, it should be understood that although one or more inventions have been specifically disclosed by the embodiments and optional features described herein, modification and variation of the concepts disclosed herein may be resorted to by those skilled in the art, and that such modifications and variations are considered to be within the scope of the one or more inventions described herein and the invention described in the appended claims.

Some embodiments of the present disclosure include a system including one or more data processors. In some embodiments, the system includes a non-transitory computer readable storage medium containing instructions which, when executed on the one or more data processors, cause the one or more data processors to perform part or all of one or more methods and/or part or all of one or more processes disclosed herein. Some embodiments of the present disclosure include a computer-program product tangibly embodied in a non-transitory machine-readable storage medium, including instructions configured to cause one or more data processors to perform part or all of one or more methods and/or part or all of one or more processes disclosed herein.

The description provides preferred exemplary embodiments only, and is not intended to limit the scope, applicability, or configuration of the disclosure. Rather, the description of the preferred exemplary embodiments will provide those skilled in the art with an enabling description for implementing various embodiments. It is understood that various changes may be made in the function and arrangement of elements without departing from the spirit and scope as set forth in the appended claims.

The present embodiments may be implemented using hardware, software, firmware, or a combination thereof. Accordingly, it is understood that any operation of the computing systems of the computing environment 100 in FIG. 1, the network environment 200 in FIG. 2, the storage platform 301 in FIG. 3, or the storage platform 700 in FIG. 5 may be implemented by a computing system using corresponding instructions stored on or in a non-transitory computer-readable medium accessible by a processing system. For the purposes of this description, a tangible computer-usable or computer-readable medium can be any apparatus that can store the program for use by or in connection with the instruction execution system, apparatus, or device. The medium may include non-volatile memory including magnetic storage, solid-state storage, optical storage, cache memory, and RAM.

The foregoing outlines features of several examples so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the examples introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method for managing snapshots associated with different schedules, the method comprising:
generating an image of a volume for a point in time that aligns with a base schedule time in a base schedule, the image including metadata pointing to data blocks stored on the volume at the base schedule time such that the image is a base snapshot of the volume at the base schedule time;
determining that the base schedule time aligns with a supplementary schedule time in a supplementary schedule; and
designating the image for use as a supplementary snapshot of the volume at the supplementary schedule time,
wherein a restoration of data corresponding to the supplementary schedule time includes computing a plurality of deltas between a plurality of base snapshots, which includes the base snapshot, created between the supplementary schedule time and an immediately preceding supplementary schedule time in the supplementary schedule.

2. The method of claim 1, wherein the base schedule comprises a series of base schedule times that occur at a first frequency and wherein the supplementary schedule comprises a series of supplementary schedule times that occur at a second frequency that is lower than the first frequency.

3. The method of claim 1, wherein the base schedule comprises a series of base schedule times that recur with respect to a base interval and wherein an interval between the supplementary schedule time and the immediately preceding supplementary schedule time is a multiple of the base interval, the multiple being greater than one.

4. The method of claim 1, wherein the base schedule comprises a series of base schedule times that recur with respect to a base interval and wherein the supplementary schedule comprises a series of supplementary schedule times that recur with respect to a supplementary interval that is a multiple of the base interval, wherein the multiple is greater than one.

5. The method of claim 1, wherein designating the image for use as the supplementary snapshot comprises:
tagging the image with a metadata tag to associate the image with the supplementary schedule and designate the image for use as the supplementary snapshot.

6. The method of claim 1, further comprising:
tagging the image with a metadata tag to associate the image with the base schedule and designate the image for use as the base snapshot, wherein the base snapshot is one of a plurality of base snapshots in a series of base snapshots.

7. The method of claim 1, wherein the base schedule is periodic and comprises a series of base schedule times that recur with respect to a base interval in which the base interval is one minute, two minutes, five minutes, ten minutes, thirty minutes, one hour, two hours, four hours, six hours, twelve hours, one day, two days, three days, four days, five days, six days, one week, ten days, two weeks, one half of a month, one month, two months, one quarter of a year, one half of a year, or one year.

8. The method of claim 1, wherein the supplementary schedule is periodic and comprises a series of supplementary schedule times that recur with respect to a supplementary interval in which the supplementary interval is two minutes, five minutes, ten minutes, thirty minutes, one hour, two hours, four hours, six hours, twelve hours, one day, two days, three days, four days, five days, six days, one week, ten days, two weeks, one half of a month, one month, two months, one quarter of a year, one half of a year, or one year.

9. The method of claim 1, wherein determining that the base schedule time aligns with the supplementary schedule time comprises:
determining that the base schedule time aligns with the supplementary schedule time based on a timestamp of the image.

10. The method of claim 1, wherein the supplementary schedule is a first supplementary schedule and the supplementary snapshot is a first supplementary schedule and further comprising:
determining that the base schedule time aligns with a scheduled time in a second supplementary schedule; and
designating the image for use as a second supplementary schedule snapshot for the secondary supplementary schedule at the scheduled time.

11. The method of claim 1, further comprising:
restoring the data for the supplementary schedule time using the plurality of deltas.

12. A computing device comprising:
a memory containing a machine-readable medium comprising machine executable code having instructions stored thereon; and
a processor coupled to the memory, the processor configured to execute the machine executable code to:
generate an image of a volume for a point in time that aligns with a base schedule time in a base schedule, the image including metadata pointing to data blocks stored on the volume at the base schedule time;
tag the image of the volume at the point in time to designate the image for use as a base snapshot of the volume at the base schedule time;
determine that the base schedule time aligns with a supplementary schedule time in a supplementary schedule; and
tag the image to designate the image for use as a supplementary snapshot of the volume at the supplementary schedule time,
wherein a restoration of data corresponding to the supplementary schedule time includes computing a plurality of deltas between a plurality of base snapshots, which includes the base snapshot, created between the supplementary schedule time and an immediately preceding supplementary schedule time in the supplementary schedule.

13. The computing device of claim 12, wherein the base schedule comprises a series of base schedule times that recur with respect to a base interval and wherein an interval between the supplementary schedule time and the immediately preceding supplementary schedule time is a multiple of the base interval, the multiple being greater than one.

14. The computing device of claim 12, wherein the base schedule comprises a series of base schedule times that occur at a first frequency and wherein the supplementary schedule comprises a series of supplementary schedule times that occur at a second frequency that is lower than the first frequency.

15. The computing device of claim 12, wherein the base schedule comprises a series of base schedule times that recur with respect to a base interval and wherein the supplementary schedule comprises a series of supplementary schedule times that recur with respect to a supplementary interval that is a multiple of the base interval, wherein the multiple is greater than one.

16. The computing device of claim 12, wherein the image is tagged with a first metadata tag to designate the image for use as the base snapshot and a second metadata tag to designate the image for use as the supplementary snapshot.

17. The computing device of claim 12, wherein the base schedule is periodic and comprises a series of base schedule times that recur with respect to a base interval in which the base interval is one minute, two minutes, five minutes, ten minutes, thirty minutes, one hour, two hours, four hours, six hours, twelve hours, one day, two days, three days, four days, five days, six days, one week, ten days, two weeks, one half of a month, one month, two months, one quarter of a year, one half of a year, or one year.

18. The computing device of claim 12, wherein the supplementary schedule is periodic and comprises a series of supplementary schedule times that recur with respect to a supplementary interval in which the supplementary interval is two minutes, five minutes, ten minutes, thirty minutes, one hour, two hours, four hours, six hours, twelve hours, one day, two days, three days, four days, five days, six days, one week, ten days, two weeks, one half of a month, one month, two months, one quarter of a year, one half of a year, or one year

19. A non-transitory machine-readable medium having stored thereon instructions for performing a method comprising machine-executable code which, when executed by at least one machine, causes the at least one machine to:
generate an image of a volume for a point in time that aligns with a base schedule time in a base schedule, the image including metadata pointing to data blocks stored on the volume at the base schedule time such that the image is a base snapshot of the volume at the base schedule time, wherein the base schedule is periodic;
determine that the base schedule time aligns with a supplementary schedule time in a supplementary schedule; and
designate the image for use as a supplementary snapshot of the volume at the supplementary schedule time,
wherein a restoration of data corresponding to the supplementary schedule time includes computing a plurality of deltas between a plurality of base snapshots, which includes the base snapshot, created between the supplementary schedule time and an immediately preceding supplementary schedule time in the supplementary schedule.

20. The non-transitory machine-readable medium of claim 16, wherein the base schedule comprises a series of base schedule times that recur with respect to a base interval and wherein an interval between the supplementary schedule time and the immediately preceding supplementary schedule time is a multiple of the base interval, the multiple being greater than one.
